(19) United States
(12) Patent Application Publication
(10) Pub. No.: US 2007/0242418 A1
(43) Pub. Date: Oct. 18, 2007

(54) Manufacturing Method of Capacitor Electrode Foil, Capacitor Electrode Foil, Laminate Type Electrolytic Capacitor and Winding Type Electrolytic Capacitor

(75) Inventor: Takenori Hashimoto, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SHOWA DENKO K.K., TOKYO (JP)

(21) Appl. No.: 11/587,794

(22) PCT Filed: Apr. 27, 2005
(86) PCT No.: PCT/JP05/08477

§ 371 Date: Oct. 27, 2006

(30) Foreign Application Priority Data
Apr. 27, 2004 (JP) 2004-130910

(51) Int. Cl. H01G 9/04; H01G 7/00

(52) U.S. Cl. 361/530; 29/25.41

(57) ABSTRACT

A method of manufacturing a capacitor electrode foil includes the steps of masking both surfaces of at least one side edge portion having a predetermined width of a strip-shaped electrode foil material with masking material along the side edge portion, etching a non-masking portion of the electrode foil material with both surfaces of at least one side portion masked with the masking material to thereby obtain the power accumulating foil after the etching to obtain the power collecting portion.

This application claims priority to Japanese Patent Application No. 2004-130910 filed on Apr. 27, 2004 and U.S. Provisional Application No. 60/634,287 filed on Dec. 9, 2004, the entire disclosures of which are incorporated herein by reference in their entireties.

### CROSS REFERENCE TO RELATED APPLICATIONS

This application is an application filed under 35 U.S.C. §111(a) claiming the benefit pursuant to 35 U.S.C. §119(e)(1) of the filing date of U.S. Provisional Application No. 60/634,287 filed on Dec. 9, 2004, pursuant to 35 U.S.C. §111(b).

### TECHNICAL FIELD

This invention relates to a manufacturing method of a capacitor electrode foil, a manufacturing method of a capacitor anode foil, a capacitor electrode foil, a capacitor anode foil, a laminate type electrolytic capacitor, and a winding type electrolytic capacitor.

### BACKGROUND ART

The following description sets forth the inventor's knowledge of related art and problems therein and should not be construed as an admission of knowledge in the prior art.

In conventional electrolytic capacitors, a terminal member (an internal terminal and external terminal) is electrically connected to a power collecting portion of an electrode foil (namely, an anode foil or a cathode foil) with various means. For example, in the case of a winding type electrolytic capacitor, mechanical fastening, such as calking or riveting, is mainly used as a connecting means for connecting the terminal member to the power collecting portion. In the case of a laminate type solid electrolytic capacitor, mechanical fastening or welding, such as laser welding, ultrasonic welding or spot welding, is used as a connecting means for connecting the terminal member to the power collecting portion.

In recent years, in accordance with the improving performance of electrical devices, capacitors are required to be low in equivalent series resistance (hereinafter “ESR”). To meet this requirement, it is preferable that the electric connection resistance between the power collecting portion and the terminal member is as small as possible.

However, in electrolytic capacitors, generally, the power collecting portion of the electrode foil is, at its front and rear surfaces, provided with an etching layer (etching pit layers) formed by etching treatment or an oxide-film formed by anodizing treatment. Therefore, there is a problem that connection of a terminal member to the power collecting portion causes increased electric connection resistance.

To solve the problem, it has been proposed to decrease the connection resistance by depositing metallic particles to the power collecting portion or to decrease the connection resistance by roughening the surface of the power collecting portion (e.g., see Japanese Unexamined Laid-open Patent Publication No. 2001-244144 (claim 1, FIG. 2), Japanese Unexamined Laid-open Patent Publication No. 2001-203127 (claim 1, FIG. 1)).

However, according to the former method, there was a possibility that the deposition film might exfoliate unintentionally. To the contrary, according to the latter method, it was difficult to set the surface roughness within a predetermined range. Thus, it was difficult to decrease connection resistance assuredly by the aforementioned methods.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

Other objects and advantages of the present invention will be apparent from the following preferred embodiments.

### DISCLOSURE OF INVENTION

The preferred embodiments of the present invention have been developed in view of the above-mentioned and/or other problems in the related art. The preferred embodiments of the present invention can significantly improve upon existing methods and/or apparatuses.

The present invention was made in view of the aforementioned technical background, and aims to provide a method of manufacturing a capacitor electrode/anode foil capable of assuredly decrease electric connection resistance between a power collecting portion of an electrode/anode foil and a terminal member, a capacitor electrode/anode foil manufactured by the method, and a laminate/winding type electrolytic capacitor using the electrode/anode foil.

To attain the aforementioned objects, the present invention provides the following means.

[1] A method of manufacturing a capacitor electrode foil having a power accumulating portion and a power collecting portion to which a terminal member is to be connected electrically, the method, comprising the steps of:

masking both surfaces of at least one side edge portion of a strip-shaped electrode foil material with masking material along the side edge portion to form a masking portion, the side edge portion having a predetermined width;

etching a non-masking portion of the electrode foil material with both surfaces of the at least one side edge portion masked with the masking material to thereby obtain the power accumulating portion, wherein the non-masking portion is a portion of the electrode foil not masked with the masking material; and

removing the masking material from the electrode foil after the etching to obtain the power collecting portion.

[2] The method of manufacturing a capacitor electrode foil as recited in the aforementioned Item [1], wherein the etching step is performed such that a plurality of non-penetrated etching pits extending from both surfaces of the non-masking portion of the electrode foil material in a thickness direction thereof are formed in the non-masking portion and that a base metal portion remains un-etched at a thickness center portion of the non-masking portion.

[3] The method of manufacturing a capacitor electrode foil as recited in the aforementioned Item [1] or [2], wherein the masking step is performed such that both surfaces of both side edge portions of the strip-shaped electrode foil material are masked with masking material along the side edge portions thereof, the side edge portions each having a predetermined width, and wherein after the etching step etched power accumulating portion of the electrode foil material is cut in a zigzag manner along a longitudinal direction of the electrode foil material.

[4] A method of manufacturing a capacitor anode foil having a power accumulating portion and a power collecting portion to which a terminal member is to be connected electrically, the method, comprising the steps of:

masking both surfaces of at least one side edge portion of a strip-shaped anode foil material with masking material along the side edge portion to form a masking portion, the side edge portion having a predetermined width;

etching a non-masking portion of the anode foil material with the masking portion masked with the masking material to thereby obtain the power accumulating portion, wherein the non-masking portion is a portion of the anode foil not masked with the masking material;

anodizing the power accumulating portion of the anode foil material with the masking portion masked with the masking material after the etching step; and

removing the masking material from the anode foil after the anodizing process to obtain the power collecting portion.

[5] The method of manufacturing a capacitor anode foil as recited in the aforementioned Item [4], wherein the etching step is performed such that a plurality of non-penetrated etching pits extending from both surfaces of the non-masking portion of the anode foil material in a thickness direction thereof are formed in the non-masking portion and that a base metal portion remains un-etched at a thickness center portion of the non-masking portion.

[6] The method of manufacturing a capacitor electrode foil as recited in the aforementioned Item [4] or [5],

wherein the masking step is performed such that both surfaces of both side edge portions of the strip-shaped anode foil material are masked with masking material along the side edge portions thereof, the side edge portions each having a predetermined width, and wherein after the anodizing process etched power accumulating portion of the anode foil material is cut in a zigzag manner along a longitudinal direction of the anode foil material.

[7] A capacitor electrode foil manufactured by the method as recited in the aforementioned Item [1]or [2].

[8] A capacitor anode foil manufactured by the method as recited in the aforementioned Item [4] or [5].

[9] A laminate type electrolytic capacitor, comprising:

a cathode foil which is the electrode foil manufactured by the method as recited in the aforementioned Item [1] or [2]; and

an anode foil which is the anode foil manufactured by the method as recited in the aforementioned Item [4] or [5].

[10] A winding type electrolytic capacitor, comprising:

a cathode foil which is the electrode foil manufactured by the method as recited in the aforementioned Item [1] or [2]; and

an anode foil which is the anode foil manufactured by the method as recited in the aforementioned Item [4] or [5].

[11] A laminate type electrolytic capacitor, comprising:

an anode foil having an anode power accumulating portion and a strip-shaped anode power collecting portion to which an anode terminal member is to be connected electrically;

a cathode foil having a cathode power accumulating portion and a strip-shaped cathode power collecting portion to which a cathode terminal member is to be connected electrically; and

a strip-shaped separator,

wherein the anode power accumulating portion of the anode foil includes a plurality of anode power accumulating units,

wherein both surfaces of each of the anode power accumulating units are etched and anodized,

wherein both surfaces of the anode power collecting portion are neither etched nor anodized over an entire region of the anode power collecting portion along a longitudinal direction thereof,

wherein the plurality of anode power accumulating units are connected to the anode power collecting portion with the anode power accumulating units protruded toward one side of the anode power collecting portion at certain intervals along the longitudinal direction thereof,

wherein the anode power collecting portion includes a plurality of first anode power collecting units to which the anode power accumulating units are connected and a plurality of second anode power collecting units located between adjacent first anode power collecting units,

wherein the cathode power accumulating portion of the cathode foil includes a plurality of cathode power accumulating units,

wherein both surfaces of the cathode power accumulating unit are etched but not anodized,

wherein both surfaces of the cathode power collecting portion are neither etched nor anodized over an entire region of the cathode power collecting portion along a longitudinal direction thereof,

wherein the plurality of cathode power accumulating units are connected to the cathode power collecting portion with the cathode power accumulating units protruded toward one side of the cathode power collecting portion at certain intervals along the longitudinal direction thereof,

wherein the cathode power collecting portion includes a plurality of first cathode power collecting units to which the cathode power accumulating units are connected and a plurality of second cathode power collecting units located between adjacent first cathode power collecting units,

wherein the anode power collecting portion of the anode foil is folded in a zigzag manner such that the second anode power collecting unit intervenes between adjacent first anode power collecting units and the plurality of anode power accumulating units become approximately parallel with each other, whereby the first anode power collecting unit and the second anode power collecting unit are laminated alternately,

wherein the cathode power collecting portion of the cathode foil is folded in a zigzag manner such that the second anode power collecting unit intervenes between adjacent first anode power collecting units and the cathode power accumulating unit intervenes between the adjacent anode power accumulating units, whereby the first cathode power collecting unit and the second cathode power collecting unit are laminated alternately,

wherein the separator is folded such that a part of the separator intervenes between the adjacent anode power accumulating unit and cathode power accumulating unit,

wherein the anode terminal member is electrically connected to the anode power collecting portion of the anode foil, and

wherein the cathode terminal member is electrically connected to the cathode power collecting portion of the cathode foil.

[12] The laminate type electrolytic capacitor as recited in the aforementioned Item [11], wherein the first anode power collecting units and the second anode power collecting units are connected with each other in an alternately laminated manner, and wherein the first cathode power collecting units and the second cathode power collecting units are connected with each other in an alternately laminated manner.

[13] The laminate type electrolytic capacitor as recited in the aforementioned Item [11] or [12],

wherein a plurality of non-penetrated etching pits formed by etching treatment are extending from both surfaces of the anode power accumulating unit toward a thickness direction thereof and a base metal portion remains at a thickness center portion of the anode power accumulating unit, and

wherein a plurality of non-penetrated etching pits formed by etching treatment are extending from both surfaces of the cathode power accumulating unit toward a thickness direction thereof and a base metal portion remains at a thickness center portion of the cathode power accumulating unit.

[14] A winding type electrolytic capacitor formed by winding a strip-shaped anode foil and a strip-shaped cathode foil with a strip-shaped separator intervening therebetween,

wherein an anode power collecting portion of a certain width to which an anode terminal member is to be connected electrically is provided along one side edge portion of the anode foil, a remaining portion of the anode foil extending from the anode power collecting portion toward the other side edge portion of the anode foil constituting an anode power accumulating portion,

wherein both surfaces of the anode power accumulating portion are etched and anodized,

wherein both surfaces of the anode power collecting portion are neither etched nor anodized over an entire region of the anode power collection portion along a longitudinal direction thereof,

wherein a cathode power collecting portion of a certain width to which a cathode terminal member is to be connected electrically is provided along one side edge portion of the cathode foil, a remaining portion of the cathode foil extending from the cathode power collecting portion toward the other side edge portion of the cathode foil constituting a cathode power accumulating portion,

wherein both surfaces of the cathode power accumulating portion are etched but not anodized,

wherein both surfaces of the cathode power collecting portion are neither etched nor anodized over an entire region of the cathode power collection portion along a longitudinal direction thereof,

wherein the anode terminal member is electrically connected to an anode connecting portion formed by cutting and bending a part of the anode power collecting portion of the anode foil, and

wherein the cathode terminal member is electrically connected to a cathode connecting portion formed by cutting and bending a part of the cathode power collecting portion of the cathode foil.

[15] The winding type electrolytic capacitor as recited in the aforementioned Item [14],

wherein a plurality of non-penetrated etching pits extending from both surfaces of the anode power accumulating portion of the anode foil are formed by etching treatment and a base metal portion remains at a thickness center portion of the anode power accumulating portion, and

wherein a plurality of non-penetrated etching pits extending from both surfaces of the cathode power accumulating portion of the cathode foil are formed by etching treatment and a base metal portion remains at a thickness center portion of the cathode power accumulating portion.

The invention according to the aforementioned items will be explained below.

In the invention as recited in the aforementioned Item [1], at least one side edge portion of the electrode foil material becomes a power collecting portion of the electrode foil. At the etching step, the non-masking portion of the electrode foil material is subjected to etching treatment in a state in which both surfaces of the side edge portion is masked. Therefore, both the surfaces of the power collecting portion of the electrode foil remain un-etched. Therefore, when a terminal member is connected to the power collecting portion, the electric connection resistance between the power collecting portion and the terminal member can be decrease assuredly. Accordingly, using this electrode foil as a cathode/anode foil of a capacitor results in reduced ESR of the capacitor.

Furthermore, since the etching step is carried out in a state in which both surfaces of the side edge portion of the electrode foil material are masked, a power collecting portion with un-etched surfaces can be easily formed assuredly.

Moreover, since a desired electrode foil can be obtained by performing the masking step, the etching step and the masking material removing step in this turn, the electrode foil can be manufactured easily.

In this invention, examples of materials of the electrode foil material includes aluminum (including its alloy, hereinafter simply referred to as “aluminum”), tantalum (including its alloy, hereinafter simply referred to as “tantalum”), niobium (including its alloy, hereinafter simply referred to as “niobium”), and titanium (including its alloy, hereinafter simply referred to as “titanium”). Examples of the terminal include an internal terminal and an external terminal, concretely, a tab terminal, a lead terminal and a lug terminal.

In this invention, the joining means for joining the power collecting portion and the terminal member is not limited to a specific one. As this joining means, mechanical joining (e.g., calking, riveting), welding (e.g., spot welding, ultrasonic welding, electron beam welding, laser welding), friction agitation welding, and soldering can be exemplified.

In the invention as recited in the aforementioned Item [2], the etching step is performed such that a plurality of non-penetrated etching pits extending from both surfaces of the non-masking portion of the electrode foil material in a thickness direction thereof are formed in the non-masking portion and that a base metal portion remains un-etched at a thickness center portion of the non-masking portion. Therefore, in the obtained electrode foil, the base metal portion remained at the thickness center portion of the power accumulating portion and the power collecting portion are connected metallically with each other. This greatly reduces the electric resistance between the power accumulating portion and the power collecting portion. Accordingly, using this electrode foil as a cathode/anode foil of a capacitor further reduces the ESR of the capacitor.

The invention as recited in the aforementioned Item [3] includes a prescribed cutting step, and therefore two electrode foils can be obtained from one electrode foil material, which enhances manufacturing of electrode foils.

In the invention as recited in the aforementioned Item [4], at least one side edge portion of an anode foil material becomes a power collecting portion of the anode foil. At the etching step, a non-masking portion of the anode foil material is subjected to etching treatment in a state in which both surfaces of the side edge portion is masked. Therefore, both the surfaces of the power collecting portion of the anode foil are remained un-etched. Furthermore, the power accumulating portion (etched portion) of the anode foil material is subjected to anodizing treatment in a state in which both the surfaces of the side edge portion are masked. Therefore, both the surfaces of the power collecting portion of the anode foil are neither etched nor anodized. Accordingly, when a terminal member is connected to this power collecting portion, the electric connection resistance between the power collecting portion and the terminal member can be reduced assuredly. As will be understood from the above, using this anode foil results in reduced ESR of a capacitor.

The etching step and the anodizing process are performed with both the surfaces of the side edge portion of the anode foil material masked, and therefore the power collecting portion in which both the surfaces are neither etched nor anodized can be obtained easily assuredly.

Furthermore, the anode foil can be obtained by performing the predetermined masking step, etching step, anodizing process and masking material removing step in order, and therefore the anode foil can be easily manufactured.

In this invention, as the material of the anode foil, valve metal can be exemplified. Concretely, aluminum, tantalum, niobium and titanium can be exemplified. Examples of the terminal member include an internal terminal and an external terminal. Concretely, a tab terminal, a lead terminal and a lug terminal can be exemplified.

In this invention, the joining means for joining the power collecting portion and the terminal member is not limited to a specific one. As the joining means, mechanical joining (e.g., calking, riveting), welding (e.g., spot welding, ultrasonic welding, electron beam welding, laser welding), friction agitation welding, and soldering can be exemplified.

According to the invention as recited in the aforementioned Item [5], in the same manner as in the invention as recited in the aforementioned Item [2], in the anode foil, the electric resistance between the power accumulating portion and the power collecting portion can be reduced significantly. As will be understood from the above, ESR of a capacitor can be further reduced.

According to the invention as recited in the aforementioned Item [6], in the same manner as in the invention as recited in the aforementioned Item [3], two anode foils can be obtained from one anode foil material, which enhances manufacturing of anode foils.

According to the invention as recited in the aforementioned Item [7], it is possible to provide a capacitor electrode foil capable of assuredly reducing the electric connection resistance between the power collecting portion and the terminal member.

According to the invention as recited in the aforementioned Item [8], it is possible to provide a capacitor anode foil capable of assuredly reducing the electric connection resistance between the power collecting portion and the terminal member.

According to the invention as recited in the aforementioned Item [9], the electric connection resistance between the power collecting portion of the electrode foil (cathode foil or anode foil) and the terminal member can be reduced assuredly, which in turn can provide a laminate type electrolytic capacitor low in ESR.

According to the invention as recited in the aforementioned Item [10], the electric connection resistance between the power collecting portion of the electrode foil (cathode foil or anode foil) and the terminal member can be reduced assuredly, which in turn can provide a winding type electrolytic capacitor low in ESR.

According to the invention as recited in the aforementioned Item [11], in the anode foil, both surfaces of the anode power collecting portion are neither etched nor anodized over an entire region of the anode power collecting portion along a longitudinal direction thereof, and the anode terminal member is electrically connected to the anode power collecting portion. Therefore, the electric connection resistance between the anode power collecting portion and the anode terminal member can be reduced assuredly. In the same manner, in the cathode foil, both surfaces of the cathode power collecting portion are neither etched nor anodized over an entire region of the cathode power collecting portion along a longitudinal direction thereof, and the cathode terminal member is electrically connected to the cathode power collecting portion. Therefore, the electric connection resistance between the cathode power collecting portion and the cathode terminal member can be reduced assuredly. Accordingly, it is possible to provide a laminate type electrolytic capacitor low in ESR.

Furthermore, in the anode foil, the anode power collecting portion is folded in a zigzag manner, whereby the first anode power collecting unit and the second anode power collecting unit constituting the anode power collecting portion are laminated alternately. Therefore, the first anode power collecting unit and the second anode power collecting unit come into contact with each other in an approximately face-to-face contact manner, increasing the contact area between them. This results in decreased electric resistance between the first anode power collecting unit and the second anode power collecting unit. In the same manner, in the cathode foil, the cathode power collecting portion is folded in a zigzag manner, whereby the first cathode power collecting unit and the second cathode power collecting unit constituting the cathode power collecting portion are laminated alternately. Therefore, the first cathode power collecting unit and the second cathode power collecting unit come into contact with each other in an approximately face-to-face contact manner, increasing the contact area between them. This results in decreased electric resistance between the first cathode power collecting unit and the second cathode power collecting unit. Accordingly, ESR of a capacitor can be further decreased.

Furthermore, since the first anode power collecting unit and the second anode power collecting unit are in contact with each other in an approximately face-to-face contact manner, the course length of current flowing from the first anode power collecting unit to the second anode power collecting unit (or from the second anode power collecting unit to the first anode power collecting unit) can be shortened. In the same manner, since the first cathode power collecting unit and the second cathode power collecting unit are in contact with each other in an approximately face-to-face contact manner, the course length of current flowing from the first cathode power collecting unit to the second cathode power collecting unit (or from the second cathode power collecting unit to the first cathode power collecting unit) can be shortened.

Furthermore, in the anode power collecting portion of the anode foil, since the second anode power collecting unit intervenes between adjacent first anode power collecting units, the second anode power collecting unit functions as a spacer for forming a gap between the adjacent anode power accumulating units. Therefore there is a merit that the cathode power accumulating unit can stably intervene between the adjacent anode accumulating units. In the same manner, in the cathode power collecting portion of the cathode foil, since the second cathode power collecting unit intervenes between adjacent first cathode power collecting units, the second cathode power collecting unit functions as a spacer for forming a gap between the adjacent cathode power accumulating units. Therefore there is a merit that the anode power accumulating unit can stably intervene between the adjacent cathode accumulating units.

According to the invention as recited in the aforementioned Item [12], in the anode power collecting portion of the anode foil, since the first anode power collecting units and the second anode power collecting units are connected with each other in an alternately laminated manner, the electric resistance between the first anode power collecting unit and the second anode power collecting unit can be decreased significantly. In the same manner, in the cathode power collecting portion of the cathode foil, since the first cathode power collecting units and the second cathode power collecting units are connected with each other in an alternately laminated manner, the electric resistance between the first cathode power collecting unit and the second cathode power collecting unit can be decreased significantly. Accordingly, ESR of the capacitor can be further decreased.

As the joining means for joining the first anode power collecting unit and the second anode power collecting unit and the joining means for joining the first cathode power collecting unit and the second cathode power collecting unit, mechanical joining (e.g., calking, riveting), welding (e.g., spot welding, ultrasonic welding, electron beam welding, laser welding), friction agitation welding, soldering, and friction pressure welding can be exemplified.

In the invention as recited in the aforementioned Item [13] in the anode power accumulating portion of the anode foil, a plurality of non-penetrated etching pits formed by etching treatment are extending from both surfaces of the anode power accumulating unit toward a thickness direction thereof and a base metal portion remains at a thickness center portion of the anode power accumulating unit. Therefore, the base metal portion remaining at the thickness center portion of the anode power accumulating unit and the anode power collecting portion are metallically connected with each other, which can significantly decrease the electric resistance between the anode power accumulating unit and the anode power collecting portion. In the same manner, in the cathode power accumulating portion of the cathode foil, a plurality of non-penetrated etching pits formed by etching treatment are extending from both surfaces of the cathode power accumulating unit toward a thickness direction thereof and a base metal portion remains at a thickness center portion of the cathode power accumulating unit. Therefore, the base metal portion remaining at the thickness center portion of the cathode power accumulating unit and the cathode power collecting portion are metallically connected with each other, which can significantly decrease the electric resistance between the cathode power accumulating unit and the cathode power collecting portion. Accordingly, ESR of the capacitor can be further decreased.

In the invention as recited in the aforementioned Item [14], in the anode foil, both surfaces of the anode power collecting portion are neither etched nor anodized over an entire region of the anode power collecting portion along a longitudinal direction thereof, and the anode terminal is electrically connected to a predetermined portion of the anode power collecting portion. Therefore, the electric connection resistance between the anode power collecting portion and the anode terminal member can be reduced assuredly. In the same manner, in the cathode foil, both surfaces of the cathode power collecting portion are neither etched nor anodized over an entire region of the cathode power collecting portion along a longitudinal direction thereof, and the cathode terminal is electrically connected to a predetermined portion of the cathode power collecting portion. Therefore, the electric connection resistance between the cathode power collecting portion and the cathode terminal member can be reduced assuredly. Accordingly, it is possible to provide a laminate type electrolytic capacitor low in ESR.

Furthermore, the anode connecting portion to which the anode terminal member is electrically connected is formed by cutting and bending a part of the anode power collecting portion, and therefore the anode connecting portion and the anode power collecting portion are metallically connected, which can significantly decrease the electric connection resistance between the anode connecting portion and the anode power collecting portion. Furthermore, there also are merits that the anode connecting portion can be formed easily and connection to the anode terminal member can be easily performed.

In the same manner, the cathode connecting portion to which the cathode terminal member is electrically connected is formed by cutting and bending a part of the cathode power collecting portion, and therefore the cathode connecting portion and the cathode power collecting portion are metallically connected, which can significantly decrease the electric connection resistance between the cathode connecting portion and the cathode power collecting portion. Furthermore, there also are merits that the cathode connecting portion can be formed easily and connection to the cathode terminal member can be easily performed.

In the invention as recited in the aforementioned Item [15], in the anode foil, a plurality of non-penetrated etching pits formed by etching treatment are extending from both surfaces of the anode power accumulating portion toward a thickness direction thereof and a base metal portion remains at a thickness center portion of the anode power accumulating portion. Therefore, the base metal portion remaining at the thickness center portion of the anode power accumulating portion and the anode power collecting portion are metallically connected with each other, which can significantly decrease the electric resistance between the anode power accumulating portion and the anode power collecting portion. In the same manner, in the cathode foil, a plurality of non-penetrated etching pits formed by etching treatment are extending from both surfaces of the cathode power accumulating portion toward a thickness direction thereof and a base metal portion remains at a thickness center portion of the cathode power accumulating portion. Therefore, the base metal portion remaining at the thickness center portion of the cathode power accumulating portion and the cathode power collecting portion are metallically connected with each other, which can significantly decrease the electric resistance between the cathode power accumulating portion and the cathode power collecting portion. Accordingly, ESR of the capacitor can be further decreased.

The present invention has the following effects.

In the invention as recited in the aforementioned Item [1], both the surfaces of the power collecting portion of the electrode foil remain un-etched. Therefore, when a terminal member is connected to the power collecting portion, the electric connection resistance between the power collecting portion and the terminal member can be decrease assuredly. Accordingly, using this electrode foil as a cathode/anode foil of a capacitor results in reduced ESR of the capacitor.

Furthermore, since the etching step carried out in a state in which both surfaces of the side edge portion of the electrode foil material are masked, a power collecting portion with no-etched surfaces can be easily formed assuredly.

Moreover, since a desired electrode foil can be obtained by performing the masking step, the etching step and the masking material removing step in this turn, the electrode foil can be manufactured easily.

In the invention as recited in the aforementioned Item [2], since the base metal portion remained at the thickness center portion of the power accumulating portion and the power collecting portion are connected metallically with each other, the electric resistance between the power accumulating portion and the power collecting portion can be reduced significantly. Accordingly, using this electrode foil as a cathode/anode foil of a capacitor further reduces the ESR of the capacitor.

According to the invention as recited in the aforementioned Item [3], two electrode foils can be obtained from one electrode foil material, which enhances manufacturing of electrode foils.

In the invention as recited in the aforementioned Item [4], since both the surfaces of the power collecting portion of the anode foil are neither etched nor anodized, when a terminal member is connected to this power collecting portion, the electric connection resistance between the power collecting portion and the terminal member can be reduced assuredly. Thus, using this anode foil results in reduced ESR of a capacitor.

The etching step and the anodizing process are performed with both the surfaces of the side edge portion of the anode foil material masked, and therefore the power collecting portion in which both the surfaces are neither etched nor anodized can be obtained easily assuredly.

Furthermore, the anode foil can be obtained by performing the predetermined masking step, etching step, anodizing process and masking material removing step in order, and therefore the anode foil can be easily manufactured.

According to the invention as recited in the aforementioned Item [5], in the same manner as in the invention as recited in the aforementioned Item [2], since the base metal portion remaining at the thickness center portion of the power accumulating portion and the power collecting portion are metallically connected with each other, the electric resistance between the power accumulating portion and the power collecting portion can be reduced significantly. Therefore, ESR of a capacitor can be further reduced.

According to the invention as recited in the aforementioned Item [6], in the same manner as in the invention as recited in the aforementioned Item [3], two anode foils can be obtained from one anode foil material, which enhances manufacturing of anode foils.

According to the invention as recited in the aforementioned Item [7], it is possible to provide a capacitor electrode foil capable of assuredly reducing the electric connection resistance between the power collecting portion and the terminal member.

According to the invention as recited in the aforementioned Item [8], it is possible to provide a capacitor anode foil capable of assuredly reducing the electric connection resistance between the power collecting portion and the terminal member.

According to the invention as recited in the aforementioned Item [9], the electric connection resistance between the power collecting portion of the electrode foil (cathode foil or anode foil) and the terminal member can be reduced assuredly, which in turn can provide a laminate type electrolytic capacitor low in ESR.

According to the invention as recited in the aforementioned Item [10], the electric connection resistance between the power collecting portion of the electrode foil (cathode foil or anode foil) and the terminal member can be reduced assuredly, which in turn can provide a winding type electrolytic capacitor low in ESR.

According to the invention as recited in the aforementioned Item [11], in the anode foil, both surfaces of the anode power collecting portion are neither etched nor anodized over an entire region of the anode power collecting portion along a longitudinal direction thereof, and the anode terminal member is electrically connected to the anode power collecting portion. Therefore, the electric connection resistance between the anode power collecting portion and the anode terminal member can be reduced assuredly. In the same manner, in the cathode foil, both surfaces of the cathode power collecting portion are neither etched nor anodized over an entire region of the cathode power collecting portion along a longitudinal direction thereof, and the cathode terminal member is electrically connected to the cathode power collecting portion. Therefore, the electric connection resistance between the cathode power collecting portion and the cathode terminal member can be reduced assuredly. Accordingly, it is possible to provide a laminate type electrolytic capacitor low in ESR.

Furthermore, in the anode foil, the anode power collecting portion is folded in a zigzag manner, whereby the first anode power collecting unit and the second anode power collecting unit constituting the anode power collecting portion are laminated alternately. Therefore, the first anode power collecting unit and the second anode power collecting unit come into contact with each other in an approximately face-to-face contact manner, increasing the contact area between them. This results in decreased electric resistance between the first anode power collecting unit and the second anode power collecting unit. In the same manner, in the cathode foil, the cathode power collecting portion is folded in a zigzag manner, whereby the first cathode power collecting unit and the second cathode power collecting unit constituting the cathode power collecting portion are laminated alternately. Therefore, the first cathode power collecting unit and the second cathode power collecting unit come into contact with each other in an approximately face-to-face contact manner, increasing the contact area between them. This results in decreased electric resistance between the first cathode power collecting unit and the second cathode power collecting unit. Accordingly, ESR of the capacitor can be further decreased.

Furthermore, since the first anode power collecting unit and the second anode power collecting unit are in contact with each other in an approximately face-to-face contact manner, the course length of current flowing from the first anode power collecting unit to the second anode power collecting unit (or from the second anode power collecting unit to the first anode power collecting unit) can be shortened. In the same manner, since the first cathode power collecting unit and the second cathode power collecting unit are in contact with each other in an approximately face-to-face contact manner, the course length of current flowing from the first cathode power collecting unit to the second cathode power collecting unit (or from the second cathode power collecting unit to the first cathode power collecting unit) can be shortened.

Furthermore, in the anode power collecting portion of the anode foil, since the second anode power collecting unit intervenes between adjacent first anode power collecting units, the second anode power collecting unit functions as a spacer for forming a gap between the adjacent anode power accumulating units. Therefore there is a merit that the cathode power accumulating unit can stably intervene between the adjacent anode accumulating units. In the same manner, in the cathode power collecting portion of the cathode foil, since the second cathode power collecting unit intervenes between adjacent first cathode power collecting units, the second cathode power collecting unit functions as a spacer for forming a gap between the adjacent cathode power accumulating units. Therefore there is a merit that the anode power accumulating unit can stably intervene between the adjacent cathode accumulating units.

According to the invention as recited in the aforementioned Item [12], in the anode power collecting portion of the anode foil, the electric resistance between the first anode power collecting unit and the second anode power collecting unit can be decreased significantly. In the same manner, in the cathode power collecting portion of the cathode foil, the electric resistance between the first cathode power collecting unit and the second cathode power collecting unit can be decreased significantly. Accordingly, ESR of the capacitor can be further decreased.

In the invention as recited in the aforementioned Item [13], in the anode power accumulating portion of the anode foil, the base metal portion remaining at the thickness center portion of the anode power accumulating unit and the anode power collecting portion are metallically connected with each other, which can significantly decrease the electric resistance between the anode power accumulating unit and the anode power collecting portion. In the same manner, in the cathode power accumulating portion of the cathode foil, the base metal portion remaining at the thickness center portion of the cathode power accumulating unit and the cathode power collecting portion are metallically connected with each other, which can significantly decrease the electric resistance between the cathode power accumulating unit and the cathode power collecting portion. Accordingly, ESR of the capacitor can be further decreased.

In the invention as recited in the aforementioned Item [14], in the anode foil, both surfaces of the anode power collecting portion are neither etched nor anodized over an entire region of the anode power collecting portion along a longitudinal direction thereof, and the anode terminal is electrically connected to a predetermined portion of the anode power collecting portion. Therefore, the electric connection resistance between the anode power collecting portion and the anode terminal member can be reduced assuredly. In the same manner, in the cathode foil, both surfaces of the cathode power collecting portion are neither etched nor anodized over an entire region of the cathode power collecting portion along a longitudinal direction thereof, and the cathode terminal is electrically connected to a predetermined portion of the cathode power collecting portion. Therefore, the electric connection resistance between the cathode power collecting portion and the cathode terminal member can be reduced assuredly. Accordingly, it is possible to provide a laminate type electrolytic capacitor low in ESR.

Furthermore, the anode connecting portion to which the anode terminal member is electrically connected is formed by cutting and bending a part of the anode power collecting portion, and therefore the anode connecting portion and the anode power collecting portion are metallically connected, which can significantly decrease the electric connection resistance between the anode connecting portion and the anode power collecting portion. Furthermore, there also are merits that the anode connecting portion can be formed easily and connection to the anode terminal member can be easily performed.

In the same manner, the cathode connecting portion to which the cathode terminal member is electrically connected is formed by cutting and bending a part of the cathode power collecting portion, and therefore the cathode connecting portion and the cathode power collecting portion are metallically connected, which can significantly decrease the electric connection resistance between the cathode connecting portion and the cathode power collecting portion. Furthermore, there also are merits that the cathode connecting portion can be formed easily and connection to the cathode terminal member can be easily performed.

In the invention as recited in the aforementioned Item [15], in the anode foil, the electric resistance between the anode power accumulating portion and the anode power collecting portion can be reduced significantly. In the same manner, in the cathode foil, the electric resistance between the cathode power accumulating portion and the cathode power collecting portion can be reduced significantly. Accordingly, ESR of the capacitor can be further decreased.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWINGS

The preferred embodiments of the present invention are shown by way of example, and not limitation, in the accompanying figures, in which:

FIG. 1 is a cross-sectional view of a laminate type electrolytic capacitor according to a first embodiment of this invention;

FIG. 2A is a perspective view of the capacitor element of the capacitor;

FIG. 2B is a perspective view seen from another angle showing the capacitor element of the capacitor;

FIG. 3 is a perspective view of the capacitor element of the capacitor in which the capacitor element is disassembled into the anode foil, the cathode foil and the separator;

FIG. 4 is a block diagram showing the manufacturing process of the anode foil of this capacitor;

FIG. 5A is a plane view showing the anode foil material after the masking step;

FIG. 5B is an enlarged cross-sectional view taken along the line A-A in FIG. 5A;

FIG. 6A is a plane view showing the anode foil material after the etching step;

FIG. 6B is an enlarged cross-sectional view taken along the line B-B in FIG. 6A;

FIG. 7A is a plane view showing the anode foil material after the anodizing process;

FIG. 7B is an enlarged cross-sectional view taken along the line C-C in FIG. 7A;

FIG. 8 is a plane view showing the anode foil material after the cutting step;

FIG. 9A is a plane view showing the anode foil material after the masking material removing step;

FIG. 9B is an enlarged cross-sectional view taken along the line D-D in FIG. 9A;

FIG. 10 is a block diagram showing the manufacturing steps of the cathode foil of this capacitor;

FIG. 11A is a plane view showing the cathode foil material after the etching step;

FIG. 11B is an enlarged cross-sectional view taken along the line E-E in FIG. 11A;

FIG. 12 is a plane view showing the cathode foil material after the cutting step;

FIG. 13A is a plane view showing the cathode foil material after the masking material removing step;

FIG. 13B is an enlarged cross-sectional view taken along the F-F in FIG. 13A;

FIG. 14 is a cross-sectional view showing a winding type electrolytic capacitor according to the second embodiment of this invention; and

FIG. 15 is a perspective view of the capacitor in which a part of the capacitor element is unwound and disassembled into the anode foil, the cathode foil and the separator.

### BEST MODE FOR CARRYING OUT THE INVENTION

In the following paragraphs, some preferred embodiments of the invention will be described by way of example and not limitation. It should be understood based on this disclosure that various other modifications can be made by those in the art based on these illustrated embodiments.

Next, some embodiments of this invention will be explained below.

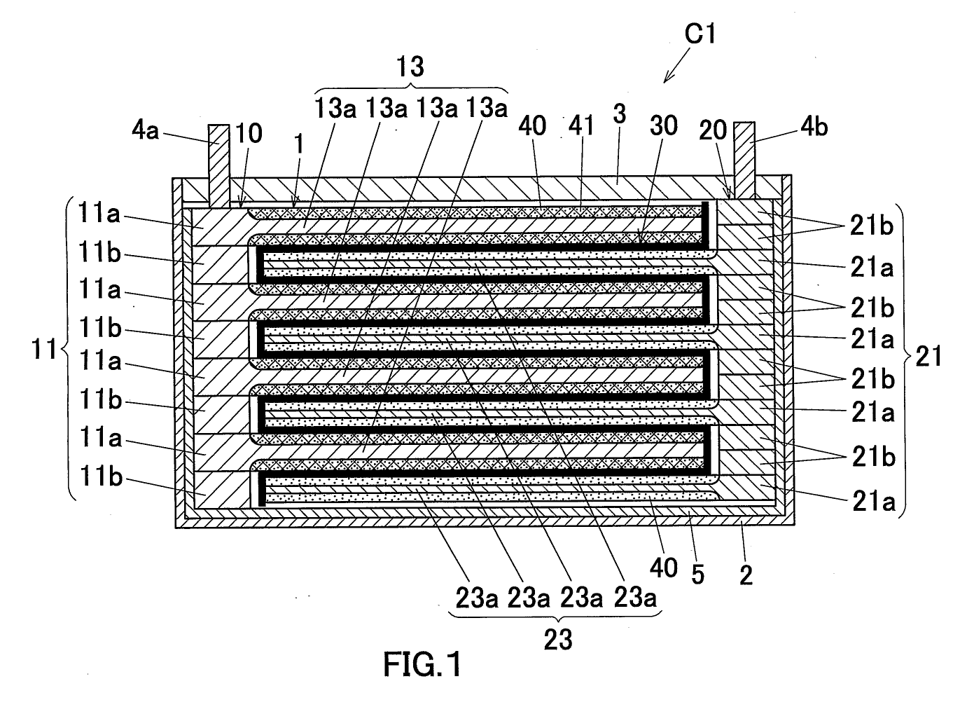

FIG. 1 is a cross-sectional view of the laminate type electrolytic capacitor C1 according to the first embodiment of this invention. Concretely, this capacitor C1 is a laminate type aluminum dry-type electrolytic capacitor.

As shown in FIG. 1, this capacitor C1 is provided with a capacitor element 1, a casing 2, a cap member 3 made of insulating material (e.g., rubber), and a pair of anode terminal 4a and cathode terminal 4b as terminal members.

The capacitor element 1 is accommodated in the casing 2. In this accommodated state, the opening of the casing 2 is closed by being covered with the cap member 3. The capacitor element 1 is impregnated with driving electrolytic solution (not shown). The reference numeral “5” denotes an insulating layer covering the external periphery of the capacitor element 1.

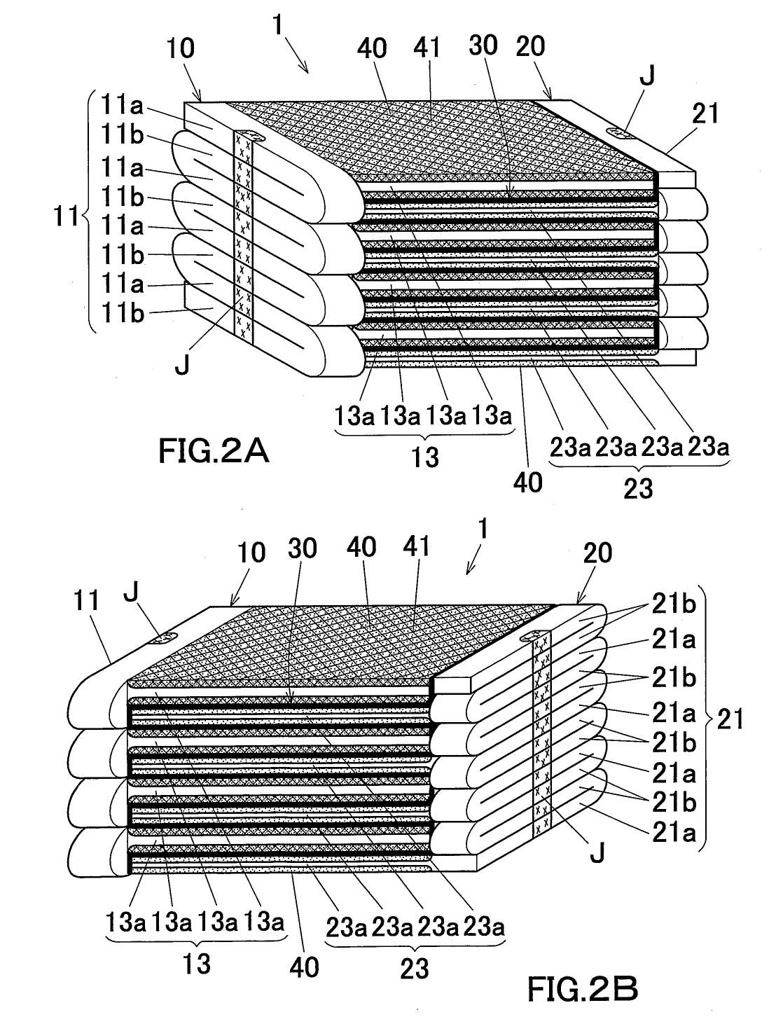

As shown in FIGS. 2A and 2B, this capacitor element 1 is equipped with a pair of anode/cathode foils 10 and 20 as electrode foils and a separator 30. Both the anode foil 10 and the cathode foil 20 are made of aluminum (including its alloy, hereinafter referred to as “aluminum”).

In this invention, both the anode foil 10 and the cathode foil 20 can be made of other than aluminum, e.g., tantalum, niobium or titanium.

Next, each structure of the anode foil 10, the cathode foil 20 and the separator 30 of the capacitor element 1 of this capacitor C1 will be explained below.

<Structure of the Anode Foil 10>

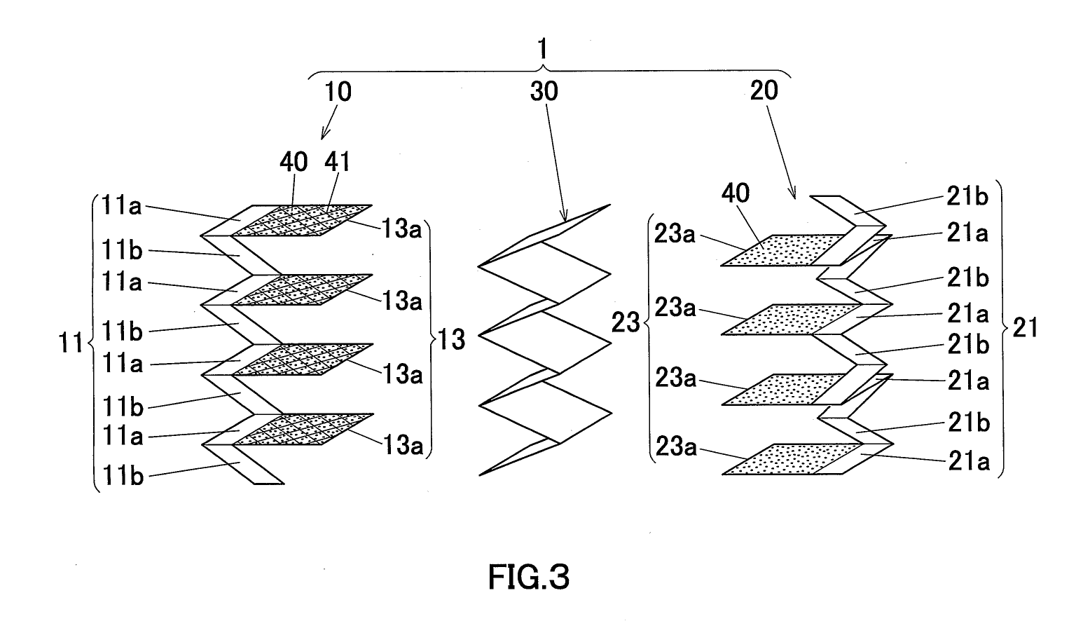

The anode foil 10 has a strip-shaped anode power collecting portion 11 of a narrow width and an anode power accumulating portion 13 as shown in the developed state in FIG. 3. To the anode power collecting portion 11, an anode terminal member 4a is to be connected electrically (see FIG. 1). The anode power accumulating portion 13 accumulates electricity. The thickness of the anode foil 10 is set to a size larger than the thickness of the cathode foil 20.

The anode power accumulating portion 13 is constituted by a plurality of anode power accumulating units 13a (four pieces in this embodiment), as shown in FIG. 3.

Each anode power accumulating unit 13a is formed into a square shape as seen from the top. To the upper and lower surfaces of this anode power accumulating unit 13a, etching treatment for roughening the surface (enlarging the surface area) and anodizing treatment for forming an oxide film layer 41 as a dielectric layer are executed in this order.

In this figure, the reference number “40” denotes an etched portion formed on the upper surface and lower surface of the anode power accumulating unit 13a by etching treatment. In this etched portion 40, a number of fine non-penetrated etching pits (not shown) are formed. On this etched portion 40, an oxide film layer 41 produced by anodizing treatment is formed.

On the other hand, on the upper surface and lower surface of the anode power collecting portion 11, neither etching treatment nor anodizing treatment is executed over the entire area along the longitudinal direction of the anode power collecting portion 11.

A plurality of anode power accumulating units 13a are connected to the anode power collecting portion 11 at certain intervals with the anode power accumulating units 13a protruded toward one side of the anode power collecting portion 11.

The anode power collecting portion 11 is constituted by a plurality of first anode power collecting units 11a (four pieces in this embodiment) to which each anode power accumulating unit 13a is connected, and a plurality of second anode power collecting units 11b each intervening between adjacent first anode power collecting units 11a and 11a.

As shown in FIG. 2A and FIG. 3, The anode power collecting portion 11 is bent in a zigzag manner such that the second anode power collecting unit 11b intervenes between adjacent first anode power collecting units 11a and 11a and that a plurality of the anode power accumulating units 13a become parallel with each other. Thus, as shown in FIG. 2A, the first anode power collecting unit 11a and the second anode power collecting unit 11b are laminated by turns.

In this invention, the second anode power collecting unit 11b can intervene between adjacent first anode power collecting units 11a and 11a in a state in which the second anode power collecting unit 11b is folded plural times, e.g., two times or three times, or is not folded as shown in FIG. 3.

Furthermore, as shown in FIG. 2A, the first anode power collecting unit 11a and the second anode power collecting unit 11b are laminated by turns and integrally joined each other by friction agitation welding. In this figure, the reference letter “J” denotes a joined portion in which the first anode power collecting unit 11a and the second anode power collecting unit 11b are joined mutually (friction agitation welded portion).

In this invention, the first anode power collecting unit 11a and the second anode power collecting unit 11b can be joined each other by, for example, mechanical joining (e.g., calking, riveting), welding (e.g., spot welding, ultrasonic welding, electron beam welding, laser welding), soldering, and friction pressure welding.

As shown in FIG. 1, the anode terminal member 4a is electrically connected to the anode power collecting portion 11 of the anode foil 10 by directly welding (e.g., spot welding, ultrasonic welding, electron beam welding, laser welding), friction agitation welding, or soldering. This anode terminal member 4a penetrates the cap member 3 outwardly.

In this invention, the anode power collecting portion 11 and the anode terminal member 4a can be electrically connected by mechanical fastening (e.g., calking, riveting).

<Structure of the Cathode Foil 20>

The cathode foil 20 has a strip-shaped cathode power collecting portion 21 of a narrow width and a cathode power accumulating portion 23 as shown in the developed state in FIG. 3. To the cathode power collecting portion 21, a cathode terminal member 4b is to be connected electrically (see FIG. 1). The cathode power accumulating portion 23 accumulates electricity.

The cathode power accumulating portion 23 is constituted by a plurality of cathode power accumulating units 23a (four pieces in this embodiment), as shown in FIG. 3.

Each cathode power accumulating unit 23a is formed into a square shape as seen from the top. To the upper and lower surfaces of this cathode power accumulating unit 23a, etching treatment for roughening the surface (enlarging the surface area) is executed, but anodizing treatment for forming an oxide film layer 41 as a dielectric layer is not executed.

In this figure, the reference number “40” denotes an etched portion formed on the upper surface and lower surface of the cathode power accumulating unit 23a by etching treatment. In this etched portion 40, a number of fine non-penetrated etching pits are formed.

On the other hand, on the upper surface and lower surface of the cathode power collecting portion 21, neither etching treatment nor anodizing treatment is executed over the entire area along the longitudinal direction of the cathode power collecting portion 21.

A plurality of cathode power accumulating units 23a are connected to the cathode power collecting portion 21 at certain intervals with the cathode power accumulating units 23a protruded toward one side of the cathode power collecting portion 21.

The anode power collecting portion 11 is constituted by a plurality of first cathode power collecting units (four pieces in this embodiment) to which each cathode power accumulating unit 23a is connected, and a plurality of second cathode power collecting units each intervening between adjacent first cathode power collecting units 21a and 21a.

As shown in FIG. 2A and FIG. 3, the cathode power collecting portion 21 is bent in a zigzag manner such that the second cathode power collecting unit 21b intervenes between adjacent first cathode power collecting units 21a and 21a and that the cathode power accumulating units 23a intervenes between the adjacent the first anode power accumulating units 13a and 13a. Thus, as shown in FIG. 2B, the first cathode power collecting unit 21a and the second cathode power collecting unit 21b are laminated by turns. In this embodiment, in detail, the second cathode power collecting unit 21b intervenes between the first cathode power collecting units 21a and 21a in a state in which the second cathode power collecting unit 21b is bent in a two-folded manner.

The reason that the second cathode power collecting unit 21b intervenes between the first cathode power collecting units 21a and 21a in a state in which the second cathode power collecting unit 21b is bent in a two-folded manner is as follows. The thickness of the anode foil 10 is generally set to a size larger than the thickness of the cathode foil 20. Therefore, the thickness of the second cathode power collecting unit 21b is doubled by folding up the second cathode power collecting unit 21b of the cathode foil 20 so that the thickness of the second cathode power collecting unit 21b conform to the thickness of the second anode power collecting unit 11b of the anode foil 10.

In this invention, the second cathode power collecting unit 21b can intervene between adjacent first cathode power collecting units 21a and 21a in a state in which the second cathode power collecting unit 21b is folded plural times, e.g., two times or three times, or is not folded as shown in FIG. 3.

Furthermore, as shown in FIG. 2B, the first cathode power collecting unit 21a and the second cathode power collecting unit 21b are laminated by turns and integrally joined each other by friction agitation welding (joined portion “J”).

In this invention, the first cathode power collecting unit 21a and the second cathode power collecting unit 21b can be joined each other by, for example, mechanical joining (e.g., calking, riveting), welding (e.g., spot welding, ultrasonic welding, electron beam welding, laser welding), soldering, and friction pressure welding.

As shown in FIG. 1, the cathode terminal member 4b is electrically connected to the cathode power collecting portion 21 of the cathode foil 20 by direct welding (e.g., spot welding, ultrasonic welding, electron beam welding, laser welding), friction agitation welding, or soldering. This cathode terminal member 4b penetrates the cap member 3 outwardly.

In this invention, the cathode power collecting portion 21 and the cathode terminal member 4b can be electrically connected by mechanical fastening (e.g., calking, riveting).

<Structure of the Separator 30>

The separator 30 is made of insulation materials, such as kraft paper or Manila fiber, and is a strip-shaped member in an unwound state.

As shown in FIGS. 2A and 2B, this separator 30 is folded in a zigzag manner such that a part (predetermined part) of the separator 30 intervenes between adjacent anode power accumulating unit 13a and cathode power accumulating unit 23a. This separator 30 is impregnated with driving electrolytic solution.

Next, the manufacturing method of the anode foil 10 and the cathode foil 20 as the capacitor element 1 of this capacitor C1 will be explained below.

<Manufacturing Method of the Anode Foil 10>

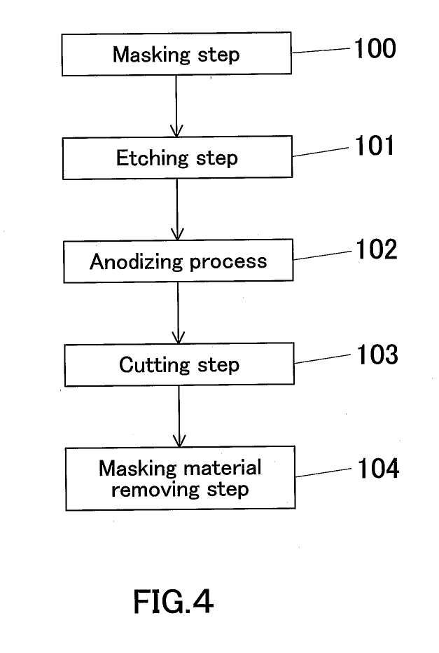

FIG. 4 is a block diagram showing the manufacturing steps of the anode foil 10. As shown in FIG. 4, the anode foil 10 is manufactured through a masking step 100, an etching step 101, an anodizing process 102, a cutting step 103, a masking material removing step 104 in this turn.

[Masking Step 100]

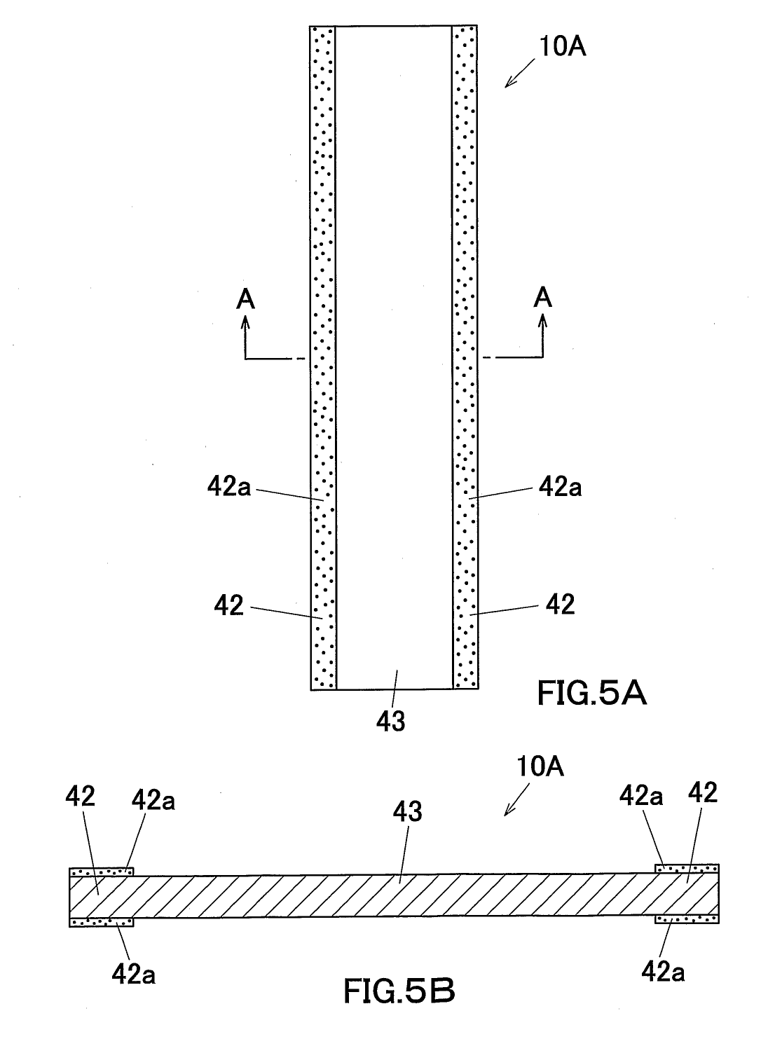

In FIGS. 5A and 5B, the reference numeral “10A” denoted an anode foil material (electrode foil material) for anode foils 10. This anode foil material 10A is made of aluminum, and is a wide strip-shaped member. The width of this anode foil material 10A is set so as to fall within the range of 2 mm to 150 mm, and the thickness thereof is set so as to fall within the range of 50 to 400 μm.

At this masking step 100, masking is preformed by applying masking material onto the upper and lower surfaces of both side edge portions of the anode foil material 10A by a printing method, such as screen-stencil printing or gravure printing, continuously along each side edge portion at a predetermined width.

In figures, the reference numeral “42” denotes a masking portion of the anode foil material 10A, and “42a” denotes a masking layer of the masking material formed on the masking portion 42 of the anode foil material 10A. Also the reference numeral “43” denotes a non-masking portion of the anode foil material 10A.

After applying the masking material, the masking material is dried.

The thickness of the masking layer 42a is set to fall within the range of 0.1 to 1 μm. Furthermore, the width of the masking layer 42a is set so as to fall within the range of 1 to 10 mm.

In this invention, although the type of the masking material is not limited to a specific one, it is preferable to use resin series paint as the masking material, more specifically, one or more paints selected from the group consisting of acrylics series paint, epoxy series paint, urethane series paint and polyester series plastic paint because of the following reasons. Such paint is relatively low in viscosity and high in strength after hardening, and therefore a masking layer 42a formed by such paint is seldom exfoliated unintentionally during the etching step, and can be exfoliated assuredly later.

[Etching Step 101]

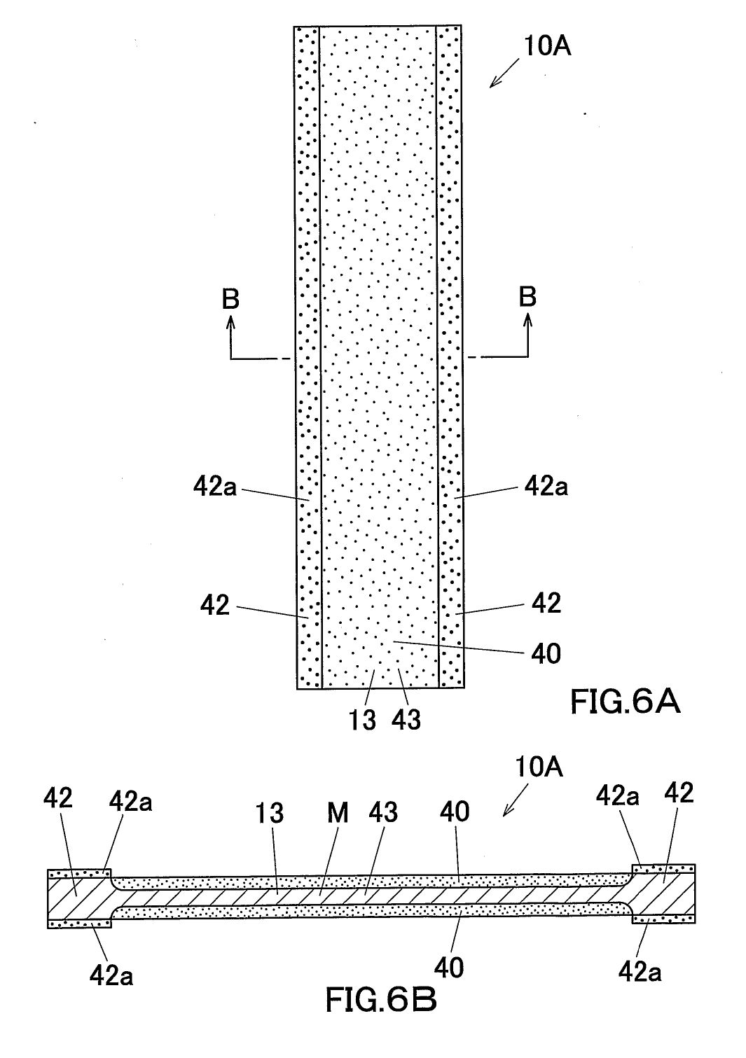

Subsequently, in the state in which the predetermined part is masked as mentioned above, etching treatment is executed by a known method such that a number of fine non-penetrated etching pits extending from the upper and lower surfaces in the thickness direction of the anode foil material 10A are formed in the non-masking portion 43 of the anode foil material 10A and that a base metal portion M remains at the thickness center portion of the non-masking portion 43. FIGS. 6A and 6B are a plane view and a cross-sectional view of the anode foil material 10A after the etching step 1011 respectively. This etching treatment is performed by immersing the entire anode foil material 10A into a prescribed etching solution in a state in which the predetermined portions are masked, and impressing AC or DC current to the anode foil material 10A if needed. In this etching treatment, chemical etching and electric etching are performed. As etching solution, inorganic acid, such as sulfuric acid and chloride, and metal salt liquid can be used for example.

By this etching treatment, as shown in FIGS. 6A and 6B, an etched portion 40 having a number of fine non-penetrated etching pits are formed in the non-masking portion 43 of an anode foil material 10A. This non-masking portion 43 will be used as an anode power accumulating portion 13 of the anode foil 10. On the other hand, un-etched portion will be formed on the masking portion 42 of the anode foil material 10A since the masking layer 42a is formed thereon.

[Anodizing Process 102]

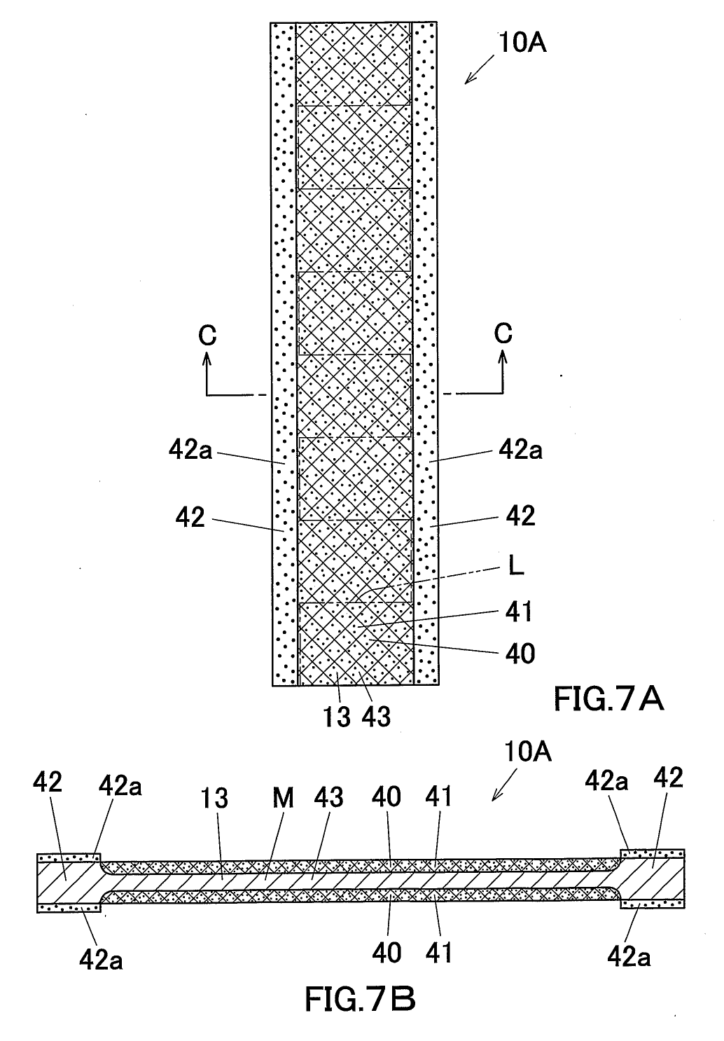

Then, anodizing treatment is performed to the anode power accumulating portion 13 of the anode foil material 10A by a known method in a state in which a predetermined part is masked. FIGS. 7A and 7B are a plane view and a cross-sectional view of the anode foil material 10A after this anodizing process 102, respectively. This anodizing treatment is performed by immersing the entire anode foil material 10A in a predetermined electrolytic solution in the state in which a predetermined part thereof is masked and impressing current to this anode foil material 10A. As the electrolytic solution, boric acid, phosphoric acid, adipic acid, etc. can be used.

By this anodizing treatment, as shown in FIGS. 7A and 7B, an oxide film layer 41 as a dielectric layer is formed on the upper and lower surfaces of the anode power accumulating portion 13 (namely, etched portion 40) of the anode foil material 10A. On the other hand, no such oxide film layer is formed on the masking portion 42 of the anode foil material 10A since the masking layer 42a is formed on the masking portion 42.

[Cutting Step 103]

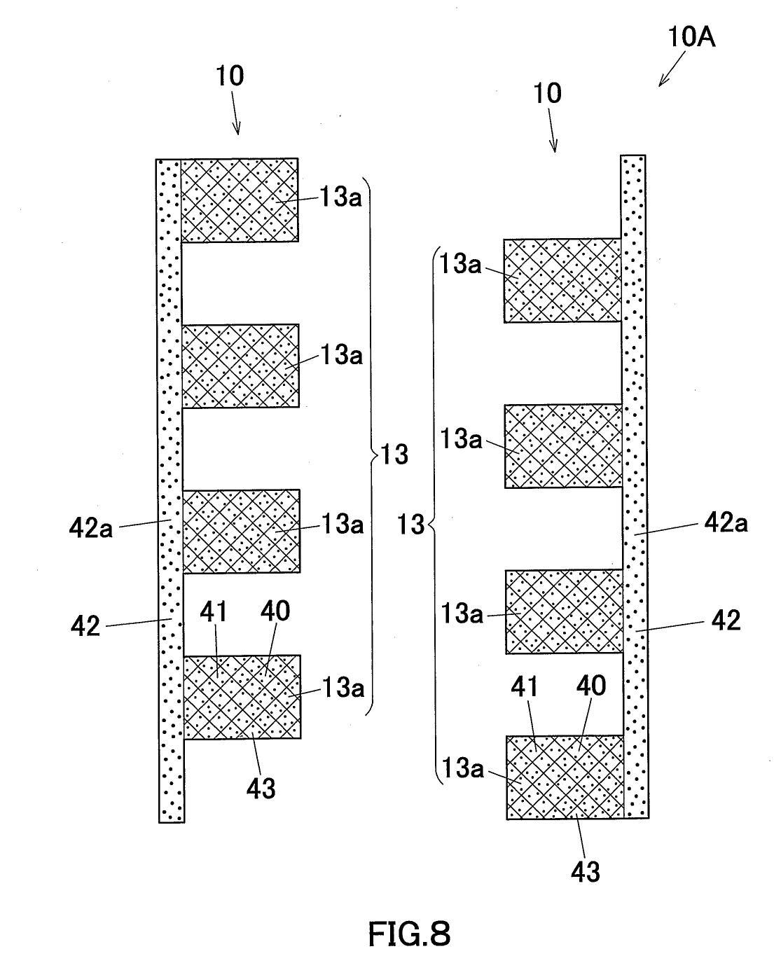

Next, the anode power accumulating portion 13 of the anode foil material 10A is cut lengthwise into two pieces along the cutting proposed line L in a zigzag manner at certain pitches. FIG. 8 is a plane view of the anode foil material 10A after the cutting step 103. In this embodiment, the cutting pitch is constant.

In this cutting, as shown in FIG. 8, two anode foils 10 and 10 same in shape can be obtained per one anode foil material 10A.

[Masking Material Removing Step 104]

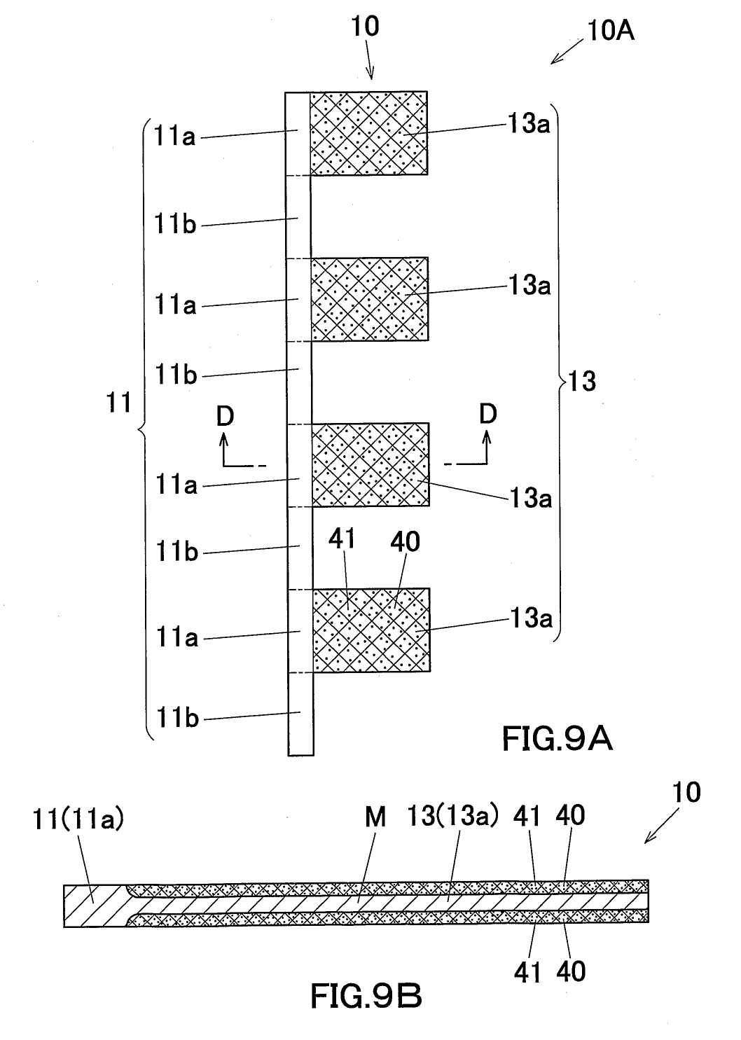

Next, the masking material (namely, masking layer 42a) of the anode foil material 10A is removed. FIG. 9A and FIG. 9B are a plane view and a cross-sectionals view of the anode foil material 10A after the masking material removal step 104, respectively. The removal of this masking material can be performed by, for example, immersing the entire anode foil material 10A in a predetermined solvent (e.g., acetone, methyl ethyl ketone, a methyl isobutyl ketone, toluene, xylene) to dissolve the masking material. The masking material removed portion becomes an anode power collecting portion 11. On the upper and lower surfaces of this anode power collecting portion 11, neither etching portion (etching layer) due to etching treatment nor oxide film layer due to anodizing treatment is formed along the entire region in the longitudinal direction.

Through the aforementioned steps, a desired anode foil 10 is obtained.

In the anode foil 10 shown in FIGS. 9A and 9B, the reference numeral “11a” is a first anode power collecting unit, “11b” denotes a second anode power collecting unit, and “13a” denotes an anode power accumulating unit. Each anode power accumulating unit 13a is connected to the corresponding first anode power collecting portion 11a with the anode power accumulating unit 13a protruded toward one side of the anode power collecting portion 11.

<Manufacturing Method of Cathode Foil 20>

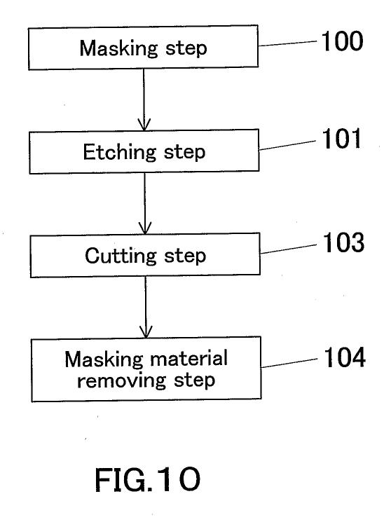

FIG. 10 is a block diagram showing the manufacturing steps of the cathode foil 20. As shown in FIG. 10, the cathode foil 20 is manufactured through a masking step 100, an etching step 101, a cutting step 103, and a masking material removing step 104 in this turn. The manufacturing steps of the cathode foil 20 do not include an anodizing process.

[Masking Step 100 and Etching Step 101]

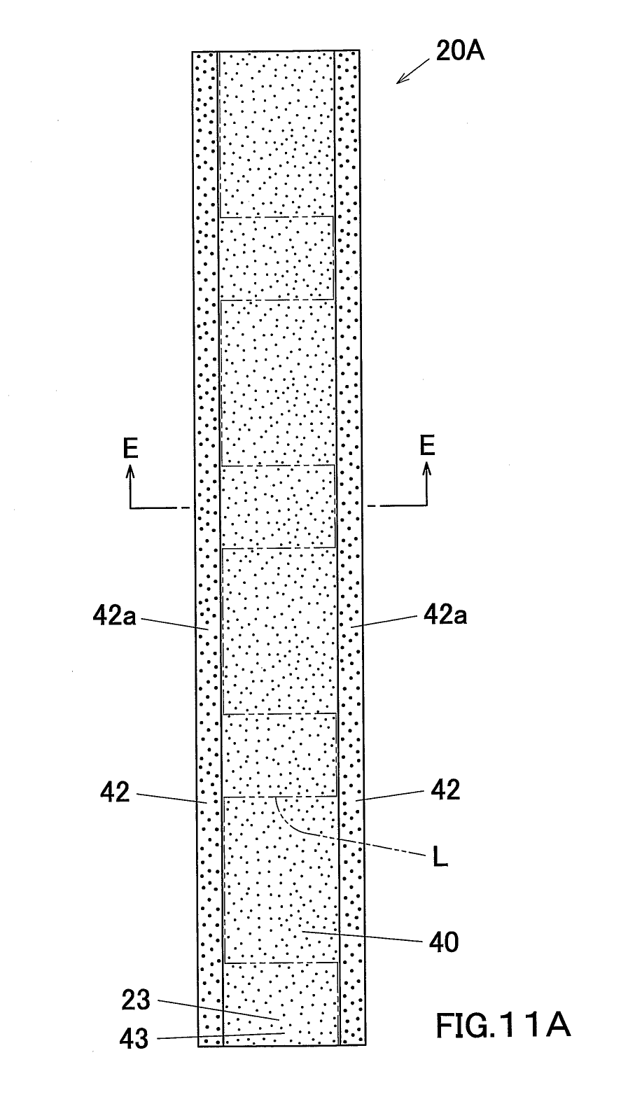

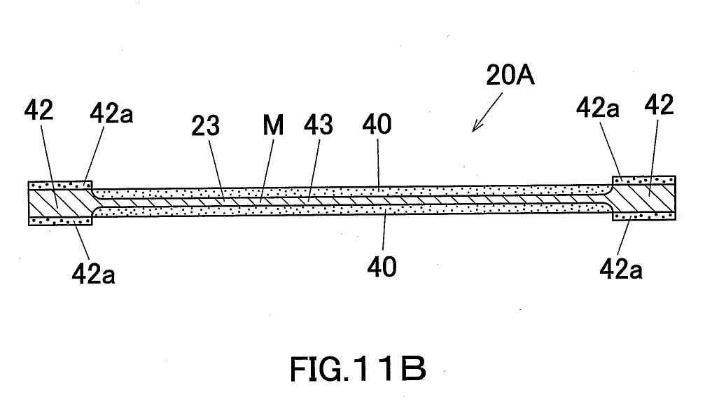

In FIGS. 11A and 11B, the reference numeral “20A” denoted a cathode foil material (electrode foil material) for cathode foils 20. This cathode foil material 20A is made of aluminum, and is a wide strip-shaped member. The width of this cathode foil material 20A is set to the same or approximately the same size as the width of the anode foil material 10A and the thickness thereof is set so as to fall within the range of 10 to 200 μm.

In the manufacturing steps of the cathode foil 20A, the masking step 100 and the etching step 101 are performed in the same manner as the masking step 100 and the etching step 101 of the anode foil material 10A mentioned above, respectively.

That is, at the masking step 100, masking is preformed by applying masking material onto the upper and lower surfaces of both side edge portions of the cathode foil material 20A continuously along each side edge portion at a predetermined width.

At the etching Step 101, in the state in which the predetermined part is masked as mentioned above, etching treatment is executed by a known method such that a number of fine non-penetrated etching pits extending from the upper and lower surfaces in the thickness direction of the cathode foil material 20A are formed in the non-masking portion 43 of the cathode foil material 20A and that a base metal portion M remains at the thickness center portion of the non-masking portion 43.

By this etching treatment, as shown in FIGS. 11A and 11B, an etched portion 40 having a number of fine non-penetrated etching pits are formed in the non-masking portion 43 of the cathode foil material 20A. This non-masking portion 43 will be used as an anode power accumulating portion 23 of the cathode foil 20. On the other hand, un-etched portion will be formed on the masking portion 42 of the cathode foil material 20A since the masking layer 42a is formed thereon.

[Cutting Step 103]

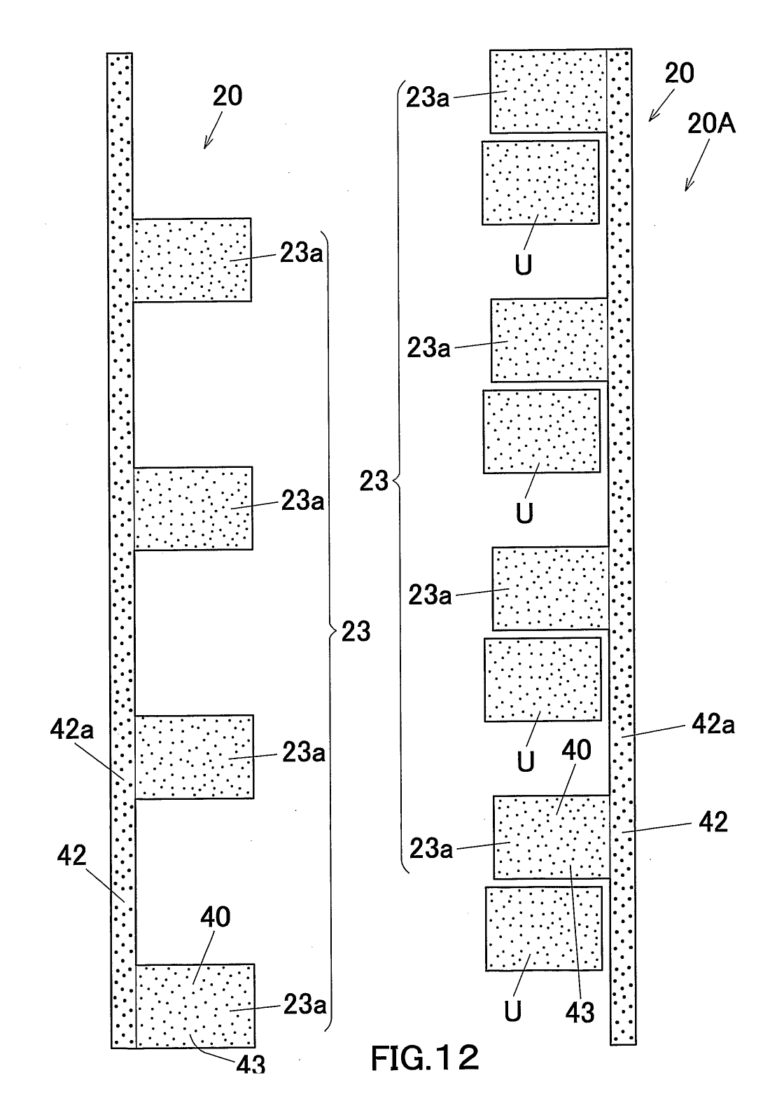

Next, the cathode power accumulating portion 23 of the cathode foil material 20A is cut lengthwise into two pieces along the cutting proposed line L in a zigzag manner at certain pitches. FIG. 12 is a plane view of the cathode foil material 20A after the cutting step 103. In this embodiment, the cathode power accumulating portion 23 of the cathode foil material 20A is cut in a zigzag manner at intervals of the repetition of 1:2 in the length direction of the cathode foil material 20A.

Furthermore, from one of the cut material 20A, an unnecessary part U of the cathode power accumulating portion 23 is cut and removed. By this cutting, as shown in FIG. 12, two cathode foils 20 and 20 can be obtained from one cathode foil material 20A.

[Masking Material Removing Step 104]

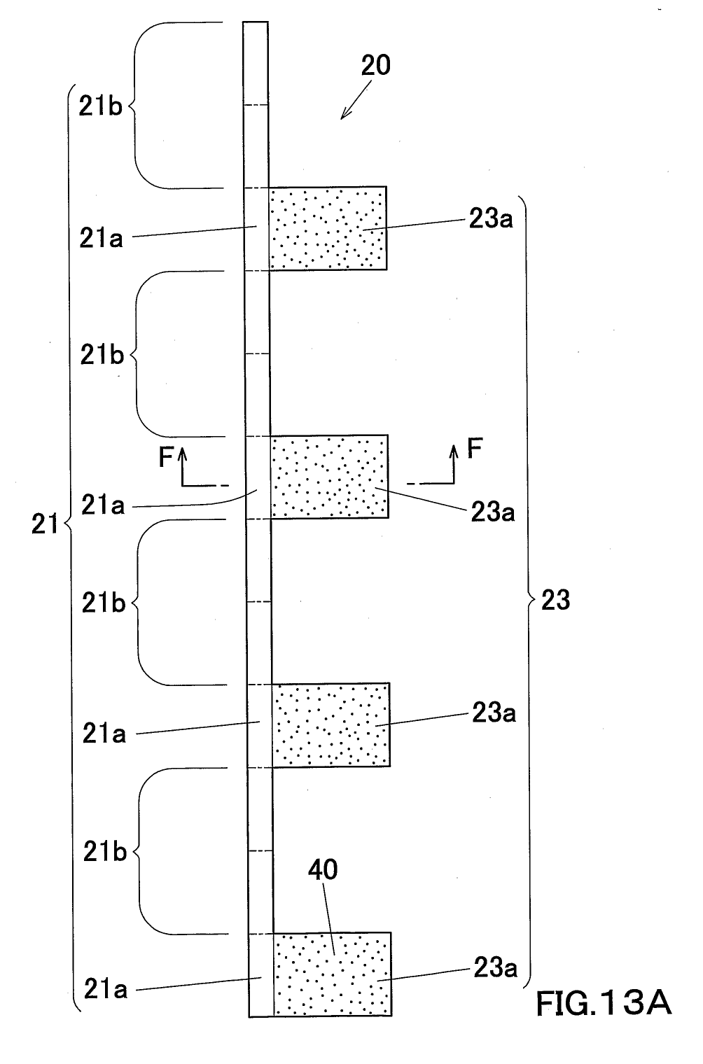

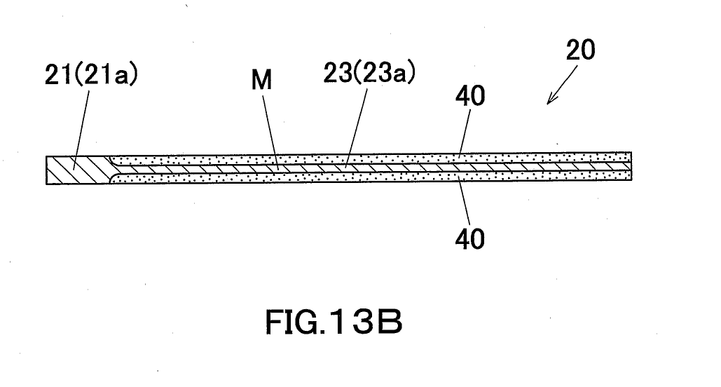

Next, the masking material (namely, masking layer 42a) of the cathode foil material 20A is removed. FIG. 13A and FIG. 13B are a plane view and a cross-sectionals view of the cathode plate foil material 20A after the masking material removing step 104, respectively. The removal of this masking material can be performed in the same manner as in the removal of the masking material from the anode foil material 10A. The masking material removed portion becomes a cathode power collecting portion 21. On the upper and lower surfaces of this cathode power collecting portion 21, neither etching portion (etching layer) due to etching treatment nor oxide film layer due to anodizing treatment is formed along the entire region in the longitudinal direction.

Through the aforementioned steps, a desired cathode foil 20 is obtained.

In the cathode foil 20 shown in FIGS. 13A and 13B, the reference numeral “21a” is a first cathode power collecting unit, “21b” denotes a second cathode power collecting unit, and “23a” denotes a cathode power accumulating unit. Each cathode power accumulating unit 23a is connected to the corresponding first cathode power collecting portion 21a with the cathode power accumulating unit 23a protruded toward one side of the cathode power collecting portion 21.

The anode and cathode foils 10 and 20 each obtained by the aforementioned manufacturing method and a known separator 30 are assembled as mentioned above into the capacitor element 1 shown in FIGS. 2A and 2B.

The manufacturing method of the anode foil 10 mentioned above has the following advantages.

The non-masking portion 43 of the anode foil material 10A is etched and anodized in a state in which the upper and lower surfaces of the both side edge portions of the anode the anode power collecting portion 11 are masked. Therefore, the upper and lower surfaces of the anode power collecting portion 11 of the anode foil 10 are neither etched nor anodized. Therefore, the electric connection resistance between the anode power collecting portion 11 and the anode terminal member 4a can be assuredly reduced when the anode terminal member 4a is connected to the anode power collecting portion 11. Accordingly, using this anode foil 10 for a laminate type electrolytic capacitor C1 results in reduced ESR of the capacitor C1.

The etching step 101 and the anodizing process 102 are performed with the upper and lower surfaces of the side edge portion of the anode foil material masked, and therefore an anode power collecting portion 11 in which both the surfaces are neither etched nor anodized can be obtained easily assuredly.

Furthermore, the anode foil 10 can be obtained by performing the predetermined masking step 100, etching step 101, anodizing process 102 and masking material removing step 104 in order, and therefore the anode foil 10 can be easily manufactured.

Furthermore, the non-masking portion 43 is subjected to etching treatment such that a plurality of non-penetrated etching pits extending from both surfaces of the anode power accumulating material 10A toward a thickness direction thereof and a base metal portion M remains at a thickness center portion of the non-masking portion 43. Therefore, in the anode foil 10 obtained as mentioned above, as shown in FIG. 9B, the base metal portion M remaining at the thickness center portion of the anode power accumulating portion 13 and the anode power collecting portion 11 are metallically connected with each other, which can significantly decrease the electric resistance between the anode power accumulating portion 13 and the anode power collecting portion 11. Accordingly, ESR of the capacitor can be further decreased.

Furthermore, the manufacturing method of this anode foil 10 includes a predetermined cutting step 103, two anode foils 10 and 10 can be obtained per one anode foil material 10A. Therefore, the anode foil 10 can be obtained efficiently.

The manufacturing method of the cathode foil 20 mentioned above has the following advantages.

The non-masking portion 43 of the cathode foil material 20A is etched and anodized in a state in which the upper and lower surfaces of the both side edge portions of the cathode power collecting portion 21 are masked. Therefore, the upper and lower surf aces of the cathode power collecting portion 21 of the cathode foil 20 are neither etched nor anodized. Therefore, the electric connection resistance between the cathode power collecting portion 21 and the cathode terminal member 4b can be assuredly reduced when the cathode terminal member 4b is connected to the cathode power collecting portion 21. Accordingly, using this cathode foil 20 for a laminate type electrolytic capacitor C1 results in reduced ESR of the capacitor C1.

The etching step 101 is performed with the upper and lower surfaces of the side edge portion of the cathode foil material 20A masked, and therefore a cathode power collecting portion 21 in which both the surfaces are neither etched nor anodized can be obtained easily assuredly.

Furthermore, a desired cathode foil 20 can be obtained by performing the predetermined masking step 100, etching step 101, and masking material removing step 104 in order, and therefore the cathode foil 20 can be easily manufactured.

Furthermore, the non-masking portion 43 is subjected to etching treatment such that a plurality of non-penetrated etching pits extending from both surfaces of the cathode power accumulating material 20A toward a thickness direction thereof and a base metal portion M remains at a thickness center portion of the non-masking portion 43. Therefore, in the cathode foil 20 obtained as mentioned above, as shown in FIG. 13B, the base metal portion M remaining at the thickness center portion of the cathode power accumulating portion 23 and the cathode power collecting portion 21 are metallically connected with each other, which can significantly decrease the electric resistance between the cathode power accumulating portion 23 and the cathode power collecting portion 21. Accordingly, ESR of the capacitor can be further decreased.

Furthermore, the manufacturing method of this cathode foil 20 includes a predetermined cutting step 103, two cathode foils 20 and 20 can be obtained per one cathode foil material 20A. Therefore, the cathode foil 20 can be obtained efficiently.

Furthermore, the laminate type electrolytic capacitor C1 according to the first embodiment has the following advantages.

In the anode foil 10, the upper and lower surfaces of the anode power collecting portion 11 are neither etched nor anodized over an entire region of the anode power collecting portion 11 along a longitudinal direction thereof, and the anode terminal member 4a is electrically connected to the anode power collecting portion 11. Therefore, the electric connection resistance between the anode power collecting portion 11 and the anode terminal member 4a can be reduced assuredly. In the same manner, in the cathode foil 20, the upper and lower surfaces of the cathode power collecting portion 21 are neither etched nor anodized over an entire region of the cathode power collecting portion 21 along a longitudinal direction thereof, and the cathode terminal member 4b is electrically connected to the cathode power collecting portion 21. Therefore, the electric connection resistance between the cathode power collecting portion 21 and the cathode terminal member 4b can be reduced assuredly.

Furthermore, in the anode foil 10, as shown in FIG. 2A, the anode power collecting portion 11 is folded in a zigzag manner, whereby the first anode power collecting unit 11a and the second anode power collecting unit 11b constituting the anode power collecting portion 11 are laminated alternately. Therefore, the first anode power collecting unit 11a and the second anode power collecting unit 11b come into contact with each other in an approximately face-to-face contact manner, increasing the contact area between them. This results in decreased electric resistance between the first anode power collecting unit 11a and the second anode power collecting unit 11b. In the same manner, in the cathode foil 20, the cathode power collecting portion 21 is folded in a zigzag manner, whereby the first cathode power collecting unit 21a and the second cathode power collecting unit 21b constituting the cathode power collecting portion 21 are laminated alternately. Therefore, the first cathode power collecting unit 21a and the second cathode power collecting unit 21b come into contact with each other in an approximately face-to-face contact manner, increasing the contact area between them. This results in decreased electric resistance between the first cathode power collecting unit 21a and the second cathode power collecting unit 21b. Accordingly, ESR of the capacitor C1 can be further decreased.

Furthermore, since the first anode power collecting unit 11a and the second anode power collecting unit 11b are in contact with each other in an approximately face-to-face contact manner, the course length of current flowing from the first anode power collecting unit 11a to the second anode power collecting unit 11b (or from the second anode power collecting unit 11b to the first anode power collecting unit 11a) can be shortened. In the same manner, since the first cathode power collecting unit 21a and the second cathode power collecting unit 21b are in contact with each other in an approximately face-to-face contact manner, the course length of current flowing from the first cathode power collecting unit 21a to the second cathode power collecting unit 21b (or from the second cathode power collecting unit 21b to the first cathode power collecting unit 21a) can be shortened.

Furthermore, as shown in FIG. 1, since the second anode power collecting unit 11b intervenes between adjacent first anode power collecting units 11a, the second anode power collecting unit 11b functions as a spacer for forming a gap between the adjacent anode power accumulating units 13a and 13a. Therefore there is a merit that the cathode power accumulating unit 23a can stably intervene between the adjacent anode accumulating units 13a and 13a. In the same manner, since the second cathode power collecting unit 21b intervenes between adjacent first cathode power collecting units 21a, the second cathode power collecting unit 21a functions as a spacer for forming a gap between the adjacent cathode power accumulating units 23a and 23a. Therefore there is a merit that the anode power accumulating unit 13a can stably intervene between the adjacent cathode accumulating units 23a and 23a.

Furthermore, in the anode power collecting portion 11 of the anode foil 10, as shown in FIG. 2A, the first anode power collecting unit 11a and the second anode power collecting unit 11b are mutually joined in the alternately laminated manner. Therefore, the electric resistance between the first anode power collecting unit 11a and the second anode power collecting unit 11b can be reduced greatly. Similarly, in the cathode power collecting portion 21 of the cathode foil 20, as shown in FIG. 2B, the first cathode power collecting unit 21a and the second cathode power collecting unit 21b are mutually joined in the alternately laminated manner, the electric resistance between the first cathode power collecting unit 21a and the second cathode power collecting unit 21b can be reduced significantly. Therefore, further reduction of ESR of the capacitor C1 can be attained, which in turn can provided a high performance capacitor C1.

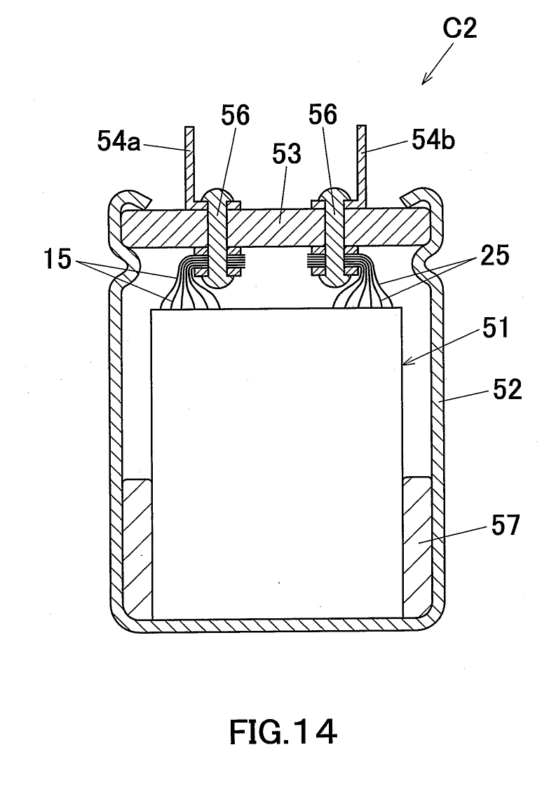

FIG. 14 is a cross-sectional view of a winding type electrolytic capacitor C2 according to the second embodiment of this invention. In detail, this capacitor C2 is a winding type aluminum dry-type electrolytic capacitor.

This capacitor C2 is provided with a capacitor element 51, a cylindrical casing 52, a cap member 53 made of insulating material (e.g., rubber) and a pair of anode external terminal 54a and cathode external terminal 54b as terminal members. In this second embodiment, the anode external terminal member 54a and the cathode external terminal member 54b are lug terminals.

The capacitor element 51 is accommodated in the casing 52. In this accommodated state, the opening of the casing 52 is closed by being covered with the cap member 53. The capacitor element 51 is impregnated with driving electrolytic solution (not shown). The reference numeral “57” denotes a fixing member for fixing the capacitor element 51 in the casing 52.

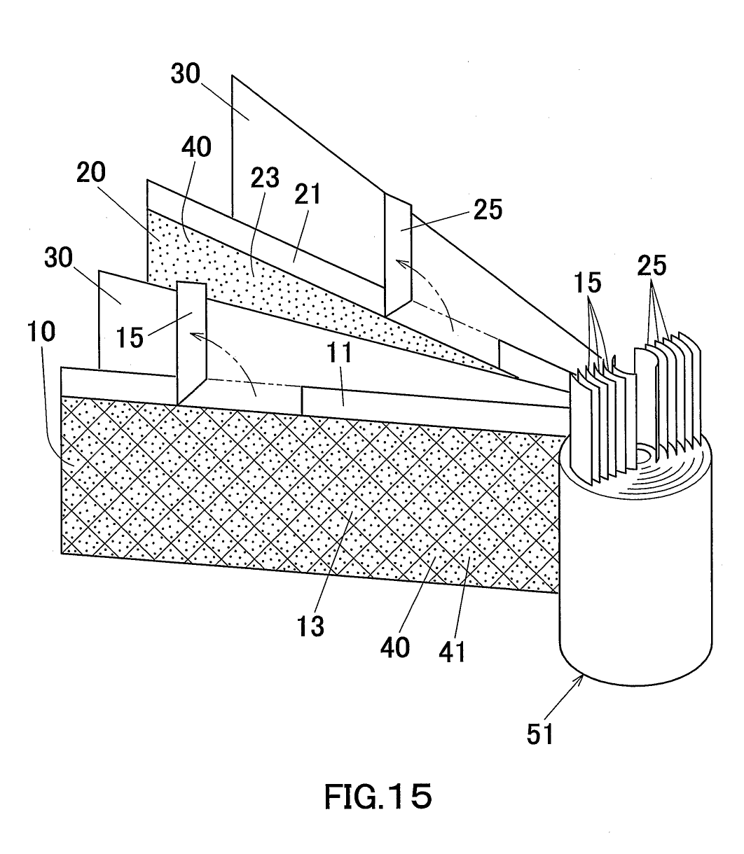

As shown in FIG. 15, this capacitor element 51 is equipped with a pair of anode/cathode foils 10 and 20 as electrode foils and a separator 30. Both the anode foil 10 and the cathode foil 20 are made of aluminum (including its alloy, hereinafter referred to as “aluminum”).

In this invention, both the anode foil 10 and the cathode foil 20 can be made of other than aluminum, e.g., tantalum, niobium or titanium.

Next, each structure of the anode foil 10, the cathode foil 20 and the separator 30 of the capacitor element 51 of this capacitor C2 will be explained below.

<Structure of the Anode Foil 10>

The anode foil 10 is a strip-shaped member as shown in the developed state in FIG. 15. To one side edge portion of the anode foil 10, an anode power collecting portion 11 to which an anode terminal member 54a is to be connected electrically is provided along the side edge portion at a certain width. The remaining portion extending from the anode power collecting portion 11 of this anode foil 10 constitutes an anode power accumulating portion 13.

In this anode foil 10, the width of the anode power collecting portion 11 is set so as to fall within the range of, for example, 2 to 10 mm. The width of the anode power accumulating portion 13 is set so as to fall within the range of, for example, 3 to 250 mm.

To the upper and lower surfaces of this anode power accumulating unit 13, etching treatment for roughening the surface (enlarging the surface area) and anodizing treatment for forming an oxide film layer 41 as a dielectric layer are executed in this order.

In this figure, the reference number “40” denotes an etched portion formed on the upper surface and lower surface of the anode power accumulating portion 13 by etching treatment. In this etched portion 40, a number of fine non-penetrated etching pits (not shown) are formed. On this etched portion 40, the oxide film layer 41 produced by anodizing treatment is formed.

On the other hand, on the upper surface and lower surface of the anode power collecting portion 11, neither etching treatment nor anodizing treatment is executed over the entire area along the longitudinal direction of the anode power collecting portion 11.

Furthermore, a part of the anode power collecting portion 11 of this anode foil 10 is cut and bent to form an anode connecting portion 15. This anode connecting portion 15 functions as an internal terminal, and is bent so as to protrude outwardly.

<Structure of the Cathode Foil 20>

The cathode foil 20 is a strip-shaped member as shown in the developed state in FIG. 15. To one side edge portion of the cathode foil 20, a cathode power collecting portion 21 to which a cathode terminal member 54b is to be connected electrically is provided along the side edge portion at a certain width. The remaining portion extending from the cathode power collecting portion 21 of this cathode foil 20 constitutes a cathode power accumulating portion 23.

In this cathode foil 20, the width of the cathode power collecting portion 21 is set so as to fall within the range of, for example, 2 to 10 mm. The width of the cathode power accumulating portion 23 is set so as to fall within the range of, for example, 3 to 250 mm.

To the upper and lower surfaces of this cathode power accumulating portion 23, etching treatment is executed but anodizing treatment is not executed. In this figure, the reference number “40” denotes an etched portion formed by etching treatment.

On the other hand, on the upper surface and lower surface of the cathode power collecting portion 21, neither etching treatment nor anodizing treatment is executed over the entire area along the longitudinal direction of the cathode power collecting portion 21.

Furthermore, a part of the cathode power collecting portion 21 of this cathode foil 20 is cut and bent to form a cathode connecting portion 25. This cathode connecting portion 25 functions as an internal terminal, and is bent so as to protrude outwardly.

<Structure of Separator 30>

The separator 30 is made of insulation materials, such as kraft paper or Manila fiber, and is a strip-shaped member in an unwound state. This separator 30 is impregnated with driving electrolytic solution.

As shown in FIG. 15, the capacitor element 51 of the winding type electrolytic capacitor C2 according to the second embodiment is manufactured by winding the anode foil 10 and the cathode foil 20 with the separator 30 intervening therebetween.

In this capacitor C2, as shown in FIG. 14, the anode external terminal member 54a is electrically connected to the anode connecting portion 15 such that the external terminal member 54a is connected to the anode connecting portion 15 of the anode foil 10 with a rivet 56. Furthermore, the cathode external terminal member 54b is electrically connected to the cathode connecting portion 25 such that the cathode external terminal member 54b is connected to the cathode connecting portion 25 of the cathode foil 20 with a rivet 56. The rivet 56 is made of metal, e.g., aluminum.

In this invention, the anode connecting portion 15 and the anode external terminal 54a, and the cathode connecting portion 25 and the cathode external terminal 54b, can be electrically joined each other by, for example, mechanical joining other than riveting (e.g., calking), welding (e.g., spot welding, ultrasonic welding, electron beam welding, laser welding), friction agitation welding, or soldering.

In this capacitor C2, the anode foil 10 is manufactured through the masking step 100, the etching step 101, the anodizing process 102, and the masking material removing step 104, which were explained in the first embodiment, in this turn. No cutting step is performed.

The cathode foil 20 is manufactured through the masking step 100, the etching step 101, and the masking material removing step 104, which were explained in the first embodiment, in this turn. No chemical converting step and cutting step is performed.

The winding type electrolytic capacitor C2 according to the second embodiment has the following advantages.

In the anode foil 10, upper and lower surfaces of the anode power collecting portion 11 are neither etched nor anodized over an entire region of the anode power collecting portion 11 along a longitudinal direction thereof, and the anode terminal member 54a is electrically connected to a predetermined portion of the anode power collecting portion 11. Therefore, the electric connection resistance between the anode power collecting portion 11 and the anode terminal member 54a can be reduced assuredly. In the same manner, in the cathode foil 20, both surfaces of the cathode power collecting portion 21 are neither etched nor anodized over an entire region of the cathode power collecting portion 21 along a longitudinal direction thereof, and the cathode terminal member 54b is electrically connected to a predetermined portion of the cathode power collecting portion 21. Therefore, the electric connection resistance between the cathode power collecting portion 21 and the cathode terminal member 54b can be reduced assuredly.

Furthermore, as shown in FIG. 15, the anode connecting portion 15a to which the anode terminal member 54a is electrically connected is formed by cutting and bending a part of the anode power collecting portion 11, and therefore the anode connecting portion 15 and the anode power collecting portion 11 are metallically connected, which can significantly decrease the electric connection resistance between the anode connecting portion 15 and the anode power collecting portion 11. Furthermore, there also are merits that the anode connecting portion 15 can be formed easily and connection to the anode terminal member 54a can be easily performed.

In the same manner, the cathode connecting portion 25 to which the cathode terminal member 54b is electrically connected is formed by cutting and bending a part of the cathode power collecting portion 21, and therefore the cathode connecting portion 25 and the cathode power collecting portion 21 are metallically connected, which can significantly decrease the electric connection resistance between the cathode connecting portion 25 and the cathode power collecting portion 21. Furthermore, there also are merits that the cathode connecting portion 25 can be formed easily and connection to the cathode terminal member 54b can be easily performed.

In the anode foil 10, the base metal portion M remaining at the thickness center portion of the anode power accumulating portion 13 and the anode power collecting portion 11 are metallically connected with each other (see FIG. 9B), which can significantly decrease the electric resistance between the anode power accumulating portion 13 and the anode power collecting portion 11. In the same manner, in the cathode power accumulating portion 23 of the anode foil 20, the base metal portion M remaining at the thickness center portion of the cathode power accumulating portion 23 and the cathode power collecting portion 21 are metallically connected with each other (see FIG. 13B), which can significantly decrease the electric resistance between the cathode power accumulating portion 23 and the cathode power collecting portion 21. Accordingly, ESR of the capacitor can be further decreased.

Although some embodiments of this invention were explained above, this invention is not limited to these embodiments and can be modified variously.

For example, although the capacitor according to the aforementioned embodiment is a dry type electrolytic capacitor, the capacitor according to this invention can be a solid electrolytic capacitor, and may be of a type other than the above.

Moreover, the capacitor and electrode foil according to this invention can be AC capacitors/electrode foils or DC capacitors/electrode foils.

### INDUSTRIAL APPLICABILITY

This invention can be applied to a manufacturing method of capacitors such as dry type electrolytic capacitors or solid electrolytic capacitors, a manufacturing method of capacitor anode foils, capacitor electrode foils, capacitor anode foils, laminate type electrolytic capacitors and winding type electrolytic capacitors.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A method of manufacturing a capacitor electrode foil having a power accumulating portion and a power collecting portion to which a terminal member is to be connected electrically, the method, comprising the steps of:
masking both surfaces of at least one side edge portion of a strip-shaped electrode foil material with masking material along the side edge portion to form a masking portion, the side edge portion having a predetermined width;
etching a non-masking portion of the electrode foil material with both surfaces of the at least one side edge portion masked with the masking material to thereby obtain the power accumulating portion, wherein the non-masking portion is a portion of the electrode foil not masked with the masking material; and
removing the masking material from the electrode foil after the etching to obtain the power collecting portion.

2. The method of manufacturing a capacitor electrode foil as recited in claim 1, wherein the etching step is performed such that a plurality of non-penetrated etching pits extending from both surfaces of the non-masking portion of the electrode foil material in a thickness direction thereof are formed in the non-masking portion and that a base metal portion remains un-etched at a thickness center portion of the non-masking portion.

3. The method of manufacturing a capacitor electrode foil as recited in claim 1, wherein the masking step is performed such that both surfaces of both side edge portions of the strip-shaped electrode foil material are masked with masking material along the side edge portions thereof, the side edge portions each having a predetermined width, and wherein after the etching step etched power accumulating portion of the electrode foil material is cut in a zigzag manner along a longitudinal direction of the electrode foil material.

4. A method of manufacturing a capacitor anode foil having a power accumulating portion and a power collecting portion to which a terminal member is to be connected electrically, the method, comprising the steps of:
masking both surfaces of at least one side edge portion of a strip-shaped anode foil material with masking material along the side edge portion to form a masking portion, the side edge portion having a predetermined width;
etching a non-masking portion of the anode foil material with the masking portion masked with the masking material to thereby obtain the power accumulating portion, wherein the non-masking portion is a portion of the anode foil not masked with the masking material;
anodizing the power accumulating portion of the anode foil material with the masking portion masked with the masking material after the etching step; and
removing the masking material from the anode foil after the anodizing process to obtain the power collecting portion.

5. The method of manufacturing a capacitor anode foil as recited in claim 4, wherein the etching step is performed such that a plurality of non-penetrated etching pits extending from both surfaces of the non-masking portion of the anode foil material in a thickness direction thereof are formed in the non-masking portion and that a base metal portion remains un-etched at a thickness center portion of the non-masking portion.

6. The method of manufacturing a capacitor electrode foil as recited in claim 4,
wherein the masking step is performed such that both surfaces of both side edge portions of the strip-shaped anode foil material are masked with masking material along the side edge portions thereof, each of the side edge portions having a predetermined width, and
wherein after the anodizing process etched power accumulating portion of the anode foil material is cut in a zigzag manner along a longitudinal direction of the anode foil material.

7. A capacitor electrode foil manufactured by the method as recited in claim 1.

8. A capacitor anode foil manufactured by the method as recited in claim 4.

9. A laminate type electrolytic capacitor, comprising:
a cathode foil which is the electrode foil manufactured by the method as recited in claim 1; and
an anode foil.

10. A winding type electrolytic capacitor, comprising:
a cathode foil which is the electrode foil manufactured by the method as recited in claim 1; and
an anode foil.

11. A laminate type electrolytic capacitor, comprising:
an anode foil having an anode power accumulating portion and a strip-shaped anode power collecting portion to which an anode terminal member is to be connected electrically;
a cathode foil having a cathode power accumulating portion and a strip-shaped cathode power collecting portion to which a cathode terminal member is to be connected electrically; and
a strip-shaped separator,
wherein the anode power accumulating portion of the anode foil includes a plurality of anode power accumulating units,
wherein both surfaces of each of the anode power accumulating units are etched and anodized,
wherein both surfaces of the anode power collecting portion are neither etched nor anodized over an entire region of the anode power collecting portion along a longitudinal direction thereof,
wherein the plurality of anode power accumulating units are connected to the anode power collecting portion with the anode power accumulating units protruded toward one side of the anode power collecting portion at certain intervals along the longitudinal direction thereof,
wherein the anode power collecting portion includes a plurality of first anode power collecting units to which the anode power accumulating units are connected and a plurality of second anode power collecting units located between adjacent first anode power collecting units,
wherein the cathode power accumulating portion of the cathode foil includes a plurality of cathode power accumulating units,
wherein both surfaces of the cathode power accumulating unit are etched but not anodized,
wherein both surfaces of the cathode power collecting portion are neither etched nor anodized over an entire region of the cathode power collecting portion along a longitudinal direction thereof,
wherein the plurality of cathode power accumulating units are connected to the cathode power collecting portion with the cathode power accumulating units protruded toward one side of the cathode power collecting portion at certain intervals along the longitudinal direction thereof,
wherein the cathode power collecting portion includes a plurality of first cathode power collecting units to which the cathode power accumulating units are connected and a plurality of second cathode power collecting units located between adjacent first cathode power collecting units,
wherein the anode power collecting portion of the anode foil is folded in a zigzag manner such that the second anode power collecting unit intervenes between adjacent first anode power collecting units and the plurality of anode power accumulating units become approximately parallel with each other, whereby the first anode power collecting unit and the second anode power collecting unit are laminated alternately,
wherein the cathode power collecting portion of the cathode foil is folded in a zigzag manner such that the second anode power collecting unit intervenes between adjacent first anode power collecting units and the cathode power accumulating unit intervenes between the adjacent anode power accumulating units, whereby the first cathode power collecting unit and the second cathode power collecting unit are laminated alternately,
wherein the separator is folded such that a part of the separator intervenes between the adjacent anode power accumulating unit and cathode power accumulating unit,
wherein the anode terminal member is electrically connected to the anode power collecting portion of the anode foil, and
wherein the cathode terminal member is electrically connected to the cathode power collecting portion of the cathode foil.

12. The laminate type electrolytic capacitor as recited in claim 11, wherein the first anode power collecting units and the second anode power collecting units are connected with each other in an alternately laminated manner, and wherein the first cathode power collecting units and the second cathode power collecting units are connected with each other in an alternately laminated manner.

13. The laminate type electrolytic capacitor as recited in claim 11,
wherein a plurality of non-penetrated etching pits formed by etching treatment are extending from both surfaces of the anode power accumulating unit toward a thickness direction thereof and a base metal portion remains at a thickness center portion of the anode power accumulating unit, and
wherein a plurality of non-penetrated etching pits formed by etching treatment are extending from both surfaces of the cathode power accumulating unit toward a thickness direction thereof and a base metal portion remains at a thickness center portion of the cathode power accumulating unit.

14. A winding type electrolytic capacitor formed by winding a strip-shaped anode foil and a strip-shaped cathode foil with a strip-shaped separator intervening therebetween,
wherein an anode power collecting portion of a certain width to which an anode terminal member is to be connected electrically is provided along one side edge portion of the anode foil, a remaining portion of the anode foil extending from the anode power collecting portion toward the other side edge portion of the anode foil constituting an anode power accumulating portion,
wherein both surfaces of the anode power accumulating portion are etched and anodized,
wherein both surfaces of the anode power collecting portion are neither etched nor anodized over an entire region of the anode power collection portion along a longitudinal direction thereof,
wherein a cathode power collecting portion of a certain width to which a cathode terminal member is to be connected electrically is provided along one side edge portion of the cathode foil, a remaining portion of the cathode foil extending from the cathode power collecting portion toward the other side edge portion of the cathode foil constituting a cathode power accumulating portion,
wherein both surfaces of the cathode power accumulating portion are etched but not anodized,
wherein both surfaces of the cathode power collecting portion are neither etched nor anodized over an entire region of the cathode power collection portion along a longitudinal direction thereof,
wherein the anode terminal member is electrically connected to an anode connecting portion formed by cutting and bending a part of the anode power collecting portion of the anode foil, and
wherein the cathode terminal member is electrically connected to a cathode connecting portion formed by cutting and bending a part of the cathode power collecting portion of the cathode foil.

15. The winding type electrolytic capacitor as recited in claim 14,
wherein a plurality of non-penetrated etching pits extending from both surfaces of the anode power accumulating portion of the anode foil are formed by etching treatment and a base metal portion remains at a thickness center portion of the anode power accumulating portion, and
wherein a plurality of non-penetrated etching pits extending from both surfaces of the cathode power accumulating portion of the cathode foil are formed by etching treatment and a base metal portion remains at a thickness center portion of the cathode power accumulating portion.

16. A capacitor electrode foil manufactured by the method as recited in claim 2.

17. A capacitor anode foil manufactured by the method as recited in claim 5.

18. A laminate type electrolytic capacitor, comprising:
a cathode foil; and
an anode foil manufactured by the method as recited in claim 4.

19. A winding type electrolytic capacitor, comprising:
a cathode foil; and
an anode foil manufactured by the method of claim 4.

20. The method of manufacturing a capacitor electrode foil as recited in claim 2, wherein the masking step is performed such that both surfaces of both side edge portions of the strip-shaped electrode foil material are masked with masking material along the side edge portions thereof, the side edge portions each having a predetermined width, and wherein after the etching step etched power accumulating portion of the electrode foil material is cut in a zigzag manner along a longitudinal direction of the electrode foil material.
